(19) United States
(12) Patent Application Publication
(10) Pub. No.: US 2026/0028481 A1
(43) Pub. Date: Jan. 29, 2026

(54) WATERBORNE SILICONE EMULSION, METHOD FOR MAKING SAME, AND COMPOSITIONS COMPRISING SUCH EMULSIONS

(71) Applicant: MOMENTIVE PERFORMANCE MATERIALS INC., Niskayuna, NY (US)

(72) Inventors: Constantine Andrew Kondos, White Plains, NY (US); Ping Jiang, New City, NY (US); Bhanu Pratap, Katihar Bihar (IN)

(21) Appl. No.: 19/280,230

(22) Filed: Jul. 25, 2025

Related U.S. Application Data
(60) Provisional application No. 63/676,654, filed on Jul. 29, 2024.

(51) Int. Cl. C08L 83/08; C08J 3/00; C09D 183/08

(52) U.S. Cl. CPC C08L 83/08; C08J 3/005; C09D 183/08

(57) ABSTRACT

A silicone emulsion comprising a (i) a first silicone emulsion comprising a polydiorganopolysiloxane grafted onto colloidal silica; and (ii) a second silicone emulsion comprising an aminosilicone. The silicone emulsion provides improved properties including, but not limited to, one or more of hardness, tensile strength, elongation, and/or thermal stability.

### CROSS-REFERENCE TO RELATED APPLICATIONS

The present application claims priority to and the benefit of U.S. Provisional Application 63/676,654 titled “WATERBORNE SILICONE EMULSION, METHOD FOR MAKING SAME, AND COMPOSITIONS COMPRISING SUCH EMULSIONS,” filed on Jul. 29, 2024, the disclosure of which is incorporated herein by reference in its entirety.

### FIELD

The present technology generally relates to a silicone emulsion, methods of making such emulsions, and the use of such emulsions to provide a film or coating.

### BACKGROUND

Coatings for some architectural or industrial applications require excellent durability and/or resistance to harsh environments. Waterborne acrylic-based polymeric binders, obtained by emulsion polymerization, are widely used and typically deliver good balance of cost and performance for architectural coatings. However, for certain applications with very high performance requirements, such as high temperature resistance, super weatherability, high water resistance, etc. acrylic based coatings may not meet the desired target.

Solvent borne or solvent-free silicone binders can typically deliver higher performance than acrylic binders in such demanding applications, however, waterborne silicone binders are preferred due to low VOC and ease-of-use. Waterborne silicone emulsions may be used for forming films or coatings. Many of these silicone compositions, however, exhibit poor mechanical properties such as, for example, low Shore A hardness, low tensile strength, low elongation, and/or low thermal degradation.

Some attempts have been made to provide resin compositions that include a silicone emulsion and an organic emulsion. Such compositions can provide some improvement in mechanical properties but overall performance like weatherability, thermal resistance, etc. are insufficient for particular applications.

### SUMMARY

Accordingly, the present invention provides a waterborne silicone emulsion. The emulsion provides coatings with good thermal resistance and mechanical properties.

In one aspect, provided is a silicone emulsion composition comprising (i) a first silicone emulsion comprising a polydiorganosiloxane grafted onto colloidal silica, and (ii) a second silicone emulsion comprising an aminosilicone.

Combining the second silicone emulsion and the first silicone emulsion has been found to provide a coating or article having improved mechanical properties. Coatings formed from the emulsion may have good weatherability and excellent mechanical properties such as one or more of high tensile strength, elongation, and/or thermal degradation. Improvements in these properties provide coatings and articles that have good rigidity and flexibility. These and other aspects and embodiments are further understood with reference to the following detailed description.

In one aspect, provided is a silicone emulsion comprising: (i) a first silicone emulsion comprising a polydiorganopolysiloxane grafted onto colloidal silica; and (ii) a second silicone emulsion comprising an aminosilicone; wherein a active weight ratio of the first silicone emulsion to the second silicone emulsion is from about 90:10 to about 10:90 based on the total weight of the first and second emulsion.

In one embodiment, the active weight ratio of the first silicone emulsion to the second silicone emulsion is from about 80:20 to about 20:80 based on the total weight of the first and second emulsion.

In one embodiment, the active weight ratio of the first silicone emulsion to the second silicone emulsion is from about 70:30 to about 30:70 based on the total weight of the first and second emulsion.

In one embodiment, the active weight ratio of the first silicone emulsion to the second silicone emulsion is from about 60:40 to about 40:60 based on the total weight of the first and second emulsion.

In one embodiment, the active weight ratio of the first silicone emulsion to the second silicone emulsion is from about 60:40 to about 90:10 based on the total weight of the first and second emulsion.

In one embodiment in accordance with any of the previous embodiments, the first silicone emulsion comprises the colloidal silica in an amount of from about 0.55 wt. % to about 50 wt. % based on the total weight of the colloidal silica and the polydiorganopolysiloxane.

In one embodiment in accordance with any of the previous embodiments, the first silicone emulsion comprises the colloidal silica in an amount of from about 7.5 wt. % to about 20 wt. % based on the total weight of the colloidal silica and the polydiorganopolysiloxane.

In one embodiment in accordance with any of the previous embodiments, the second emulsion has an amine content of from about 0.05 wt. % to about 10 wt. % based on the total weight of the second emulsion.

In one embodiment in accordance with any of the previous embodiments, the amino silicone emulsion comprises a polyorganosiloxane having an amino silane group at a terminal position of the polyorganosiloxane and/or pendant position to a silicon atom in a chain of the polyorganosiloxane.

In one embodiment in accordance with any of the previous embodiments, the second emulsion comprises an amine group derived from an aminosilane of the formula:

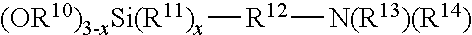

where R¹⁰ is a C1-C8 alkyl;
R¹¹ is selected from H, a C1-C12 alkyl, or C3-C10 cycloalkyl, or a C6-C30 aromatic containing group;
R¹² is selected from a C1-C12 alkylene;
R¹³ and R¹⁴ are independently selected from H, a C1-C12 alkyl, or —R¹⁵—N(R¹⁶)(R¹⁷), where R¹⁵ is a C1-C12 alkylene, R¹⁶ and R¹⁷ are independently selected from H and a C1-C12 alkyl; and
x is 0, 1, or 2

In one embodiment in accordance with any of the previous embodiments, the second emulsion comprises an amino group derived from aminopropyltrimethoxysilane, aminopropyltrimethoxysilane, aminobutyltriethoxysilane, aminoethylaminoisobutylmethyldiethoxysilane, p-aminophenyltrimethoxysilane, N-(2-aminoethyl-3-aminopropyl)triethoxysilane, aminoundecyltrimethoxysilane, and aminopropylmethyldiethoxysilane, phenylaminopropyltriemthoxy silane, methylaminopropyltriemthoxysilane, n-butylaminopropyltrimethoxy silane, t-butyl aminopropyltrimethoxysilane, N-methyl-3-amino-2-methylpropyltriemthoxysilane, N-ethyl-3-amino-2-methylpropyltrimethoxysilane, N-ethyl-3-amino-2-methylpropyidiethoxysilane, N-ethyl-3-amino-2-methylpropyoltriethoxysilane, N-ethyl-3-amino-2-methylpropylmethyidimethoxysilane, N-butyl-3-amino-2-methylpropyltriemthoxysilane, 3-(N-methyl-3-amino-1-methyl-1-ethoxy)propyltrimethoxysi lane, N-ethyl-4-amino-3,3-dimethylbutyidimethoxymethylsilane and N-ethyl-4-amino-3,3-dimethylbutyltrimethoxysilane, or N-cyclohexylaminopropyltrimethoxysilane, bis(trimethoxysilylpropyl)amine, bis((3-trimethoxysilyl)propyl)-ethylenediamine.

In one embodiment in accordance with any of the previous embodiments, the second emulsion comprises a cationic surfactant.

In one embodiment in accordance with any of the previous embodiments, the second emulsion comprises a nonionic surfactant.

In one embodiment in accordance with any of the previous embodiments, the first emulsion comprises an emulsion of at least one hydroxylated polydiorganopolysiloxane grafted onto at least one colloidal silica dispersion; at least one catalyst; at least one emulsion stabilizer; at least one surfactant; and water, wherein the at least one hydroxylated polydiorganopolysiloxane grafted onto the at least one colloidal silica dispersion contains residual silanol groups from the at least one hydroxylated polydiorganopolysiloxane.

In one embodiment, the hydroxylated polydiorganosiloxane has a weight average molecular weight of from about 250 to about 1,000,000.

In one embodiment in accordance with any of the previous embodiments, the hydroxylated polydiorganosiloxane is a hydroxyl-terminated polydimethylsiloxane.

In one embodiment in accordance with any of the previous embodiments, the colloidal silica dispersion comprises silica particles having an average particle size of from about 5 to about 150 nanometers.

In another aspect, provided is a coating composition comprising the silicone emulsion of any of the previous embodiments.

In one embodiment, the coating comprises one or more of an organic resin, a polysiloxane resin, a solvent, a filler, a dispersing agent, a wetting agent, a defoamer, a plasticizer, a thickener, a wax, a colorant, an antioxidant, a UV stabilizer, a biocide, a coalescing agent, or a combination of two or more thereof.

In still another aspect, provided is a coating or article formed from the silicone emulsion or coating composition of any of the previous embodiments.

In yet another aspect, provided is an article comprising the silicone emulsion or coating composition of any of the previous embodiments disposed on at least a portion of a surface of the article. In one embodiment, the article comprises a coating formed from the silicone emulsion.

In a further aspect, provided is a method of making a silicone emulsion comprising mixing (i) a first silicone emulsion comprising a polydiorganopolysiloxane grafted onto colloidal silica; and (ii) a second silicone emulsion comprising an aminosilicone, wherein an active weight ratio of the first silicone emulsion to the second silicone emulsion is from about 90:10 to about 10:90 based on the total weight of the first and second emulsion.

### DETAILED DESCRIPTION

The present invention generally provides a silicone emulsion composition, coatings and films formed from such compositions, and articles comprising the same. The silicone emulsions may be used as a coating and can be employed to form a film or coating layer on a surface of an article. The silicone emulsions can provide a waterborne silicone coating, which upon casting and drying, produces a film having good elasticity, water resistance, durability, thermal and/or fire resistance, scratch resistance and may have other desirable properties such as one or more of good tensile strength, a relatively high elongation, and/or high hardness.

The silicone emulsion composition comprises (i) a first silicone emulsion comprising the reaction product of a hydroxylated silicone with colloidal silica, and (ii) a second silicone emulsion selected from an aminosilicone emulsion.

Silicone Emulsion with Colloidal Silica

The silicone emulsion composition comprises a first silicone emulsion with colloidal silica. In embodiments, the silicone emulsion with colloidal silica is a silicone emulsion that is the reaction product of a silicone fluid with a colloidal silica to form a crosslinkable silicone moiety, and water, a surfactant, such as an anionic surfactant and/or non-ionic surfactant, a catalyst, and an emulsion stabilizer.

The silicone fluid may be chosen from a hydroxylated silicone fluid. In an embodiment, suitable hydroxylated silicone fluids are hydroxylated, polydiorganosiloxanes. The hydroxylated polydiorganosiloxanes suitable for use in the first silicon emulsion include those that can be emulsified, and which will impart elastomeric properties when reacted with the colloidal silica and after the removal of the water from the reaction product. The term “hydroxylated polydiorganosiloxane” includes, but is not limited to, polymers that are essentially a linear species of repeating diorganosiloxane units and polymeric species that contain small numbers of monoorganosiloxane units, up to a maximum of about five monoorganosiloxane unit per 100 diorganosiloxane units, more preferably one monoorganosiloxane unit per 100 diorganosiloxane units. The hydroxylated polydiorganosiloxanes may have an average of about two silicon-bonded hydroxyls per molecule up to a number of silicon-bonded hydroxyls that is equal to one silicon-bonded hydroxyl for each monoorganosiloxane in the hydroxylated polydiorganosiloxane molecule plus the two chain-terminating silicon-bonded hydroxyls. In embodiments, the hydroxylated polydiorganosiloxane comprises about two silicon-bonded hydroxyls per molecule.

Suitable hydroxylated polydiorganosiloxanes are those which have an elastomeric property when the hydroxylated polydiorganosiloxanes are reacted with the colloidal silica and after the removal of the water from the emulsion. In one embodiment, the hydroxylated polydiorganosiloxane has a weight average molecular weight (Mw) of at least about 5,000, more preferably from about 5,000 to about 1,000,000, even more preferably from about 100,000 to about 1,000,000, yet even more preferably from about 200,000 to about 1,000,000 and still yet more preferably from about 500,000 to about 1,000,000. In embodiments, the weight average molecular weights for the hydroxylated polydiorganosiloxane containing at least one monoorganosiloxane unit is in the range of about 100,000 to about 1,000,000, more preferably from about 200,000 to about 700,000, even more preferably from about 400,000 to about 600,000.

In another embodiment, the weight average molecular weight for the hydroxylated polydiorganosiloxane, including the hydroxylated polydiorganosiloxane containing at least one monoorganosiloxane unit is determined in accordance with ASTM D5296-11, Standard Test Method for Molecular Weight Averages and Molecular Weight Distribution of Polystyrene by High Performance Size-Exclusion Chromatograph.

In still another embodiment, the hydroxylated polydiorganosiloxane is a compound having the structure of Formula (1):

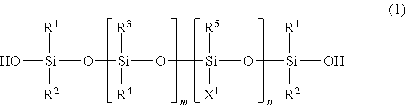

wherein:
each occurrence of R¹ and R² is independently selected from the group consisting of a hydroxyl group, an alkyl group having from 1 to 10 carbon atoms, an alkyl group having from 1 to 10 carbon atoms and substituted with at least one fluoro group, an aryl group having from 6 to 10 carbon atoms, a cycloalkyl group having from 3 to 10 carbon atoms, an alkenyl group containing 2 to 10 carbon atoms and an aralkyl group having from 7 to 12 carbon atoms, more preferably R¹ and R² are independently chosen from methyl, ethyl, or phenyl, and even more preferably methyl;
each occurrence of R³, R⁴, and R⁵ is independently selected from the group consisting of an alkyl group having from 1 to 10 carbon atoms, an alkyl group having from 1 to 10 carbon atoms and substituted with at least one fluoro group, an aryl group having from 6 to 10 carbon atoms, a cycloalkyl group having from 3 to 10 carbon atoms, an alkenyl group containing 2 to 10 carbon atoms and an aralkyl group having from 7 to 12 carbon atoms, more preferably each occurrence of R³, R⁴, and R⁵ is independently selected from methyl, ethyl, or phenyl, and even more preferably methyl;
each occurrence of X¹ is independently a group having the structure of Formula (2):

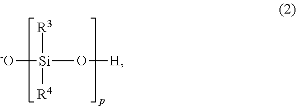

wherein each occurrence of R³ and R⁴ is independently selected from the group consisting of an alkyl group having from 1 to 10 carbon atoms, an alkyl group having from 1 to 10 carbon atoms and substituted with at least one fluoro group, an aryl group having from 6 to 10 carbon atoms, a cycloalkyl group having from 3 to 10 carbon atoms, an alkenyl group containing 2 to 10 carbon atoms and an aralkyl group having from 7 to 12 carbon atoms. In embodiments, each occurrence of R³ and R⁴ in Formula (2) are independently chosen from methyl, ethyl, or phenyl, and in embodiments R³ and R⁴ are methyl;
wherein the subscript m, n, and p are integers independently chosen such that the weight average molecular weight of the material has a weight average molecular weight satisfying the values or the ranges described above. In another embodiment, m, n, and p are integers, wherein m is from about 65 to about 13,500, n is from 0 to about 135, p is from 0 to about 1,000, m is from 130 to 10,000, n is from 0 to 13 and p is from 0 to about 100, m is from about 325 to 2,700, n is from 0 to about 5 and p is from 0 to 10; or m is from about 650 to 1,350, n is 0 or 1 and p is 0, with the provisos that
(i) the molar ratio of m:n is from about 100:0 to about 100:5, from about 100:0 to about 100:1 and even more preferably about 100:0, and
(ii) the sum of m+n+p is from about 65 to about 13,500.

The organic groups of the hydroxylated polydiorganosiloxane can be monovalent alkyl groups containing less than seven carbon atoms and 2-(perfluoroalkyl)ethyl groups containing less than seven carbon atoms. Representative and non-limiting alkyl groups include methyl, ethyl, propyl, butyl, isopropyl, pentyl, and hexyl. Representative and non-limiting examples of alkenyl groups include vinyl and allyl. Representative and non-limiting examples of cycloalkyl groups include cyclopentyl, cyclohexyl, cyclooctyl, and cyclodecyl. Representative and non-limiting examples of aryl groups are phenyl and tolyl; and non-limiting examples of aralkyl groups are benzyl or phenethyl. Representative and non-limiting examples of 2-(perfluoroalkyl)ethyl groups include 3,3,3-trifluoropropyl and 2-(perfluorobutyl)ethyl. In still another embodiment, the hydroxylated polydiorganosiloxanes may contain organic groups in which at least 50 mole percent are methyl. In one embodiment, the hydroxylated polydiorganosiloxane is a hydroxyl-terminated polydimethylsiloxane.

The emulsion of the hydroxylated polydiorganosiloxane may be prepared using a non-ionic surfactant, an anionic surfactant, or a combination thereof. In one embodiment, the hydroxylated polydiorganosiloxane is preferably an anionic surfactant. This emulsion of the hydroxylated polydiorganosiloxane prepared using anionic surfactants may be referred to as an anionically stabilized silicone fluid. The non-ionic or anionic surfactant may be chosen from any suitable surfactant as may be desired and suitable for the intended purpose. Examples of suitable anionic surfactants include, but are not limited to, carboxylic acid surfactants, sulfuric acid surfactants, sulfonic acid surfactants, phosphoric acid surfactants, salts of such surfactants, or a combination of two or more surfactants thereof.

Representative and non-limiting examples of carboxylic acid surfactants include, for example, a carboxylic acid, such as poly acrylic acid, poly methacrylic acid, poly maleic acid, poly maleic anhydride, a copolymer of maleic acid or maleic anhydride and an olefin, as, for example, ethylene, propylene, isobutylene, diisobutylene, and the like, a copolymer of acrylic acid and itaconic acid, a copolymer of methacrylic acid and itaconic acid, a copolymer of maleic acid or maleic anhydride and styrene, a copolymer of acrylic acid and methacrylic acid, a copolymer of acrylic acid and methyl acrylate ester, a copolymer of acrylic acid and vinyl acetate, a copolymer of acrylic acid and maleic acid or maleic anhydride, a polyoxyethylene alkyl ether acetic acid where the alkyl group has from 4 to 28 carbon atoms, more preferably from 8 to 18 carbon atoms, an N-methyl-fatty acid sarcosinate where the fatty acid has from 4 to 28 carbon atoms, more preferably from 8 to 18 carbon atoms, a resin acid, and a fatty acid having 4 to 28 carbon atoms, more preferably from 8 to 18 carbon atoms, and salts of these carboxylic acids.

Representative and non-limiting examples of sulfuric acid ester surfactants include for example, a sulfuric acid ester, such as an alkyl sulfuric acid ester where the alkyl group has from 4 to 28 carbon atoms, more preferably from 8 to 18 carbon atoms, a polyoxyethylene alkyl ether sulfuric ester where the alkyl group has from 4 to 28 carbon atoms, more preferably from 8 to 18 carbon atoms, a polyoxyethylene mono or di alkyl phenyl ether sulfuric acid ester where the alkyl group has from 4 to 28 carbon atoms, more preferably from 8 to 18 carbon atoms, a sulfuric acid ester of a polymer of a polyoxyethylene mono or di alkyl phenyl ether where the alkyl group has from 4 to 28 carbon atoms, more preferably from 8 to 18 carbon atoms, a polyoxyethylene mono, di, or tri phenyl ether sulfuric acid ester, a polyoxyethylene mono, di, or tri benzyl phenyl ether sulfuric acid ester, a polyoxyethylene mono, di, or tri styryl phenyl ether sulfuric acid ester, a sulfuric acid ester of a polymer of a polyoxyethylene mono, di, or tri styryl phenyl ether, a sulfuric acid ester of a polyoxyethylene polyoxypropylene block polymer, a sulfated oil, a sulfated fatty acid ester, a sulfated fatty acid, and a sulfated olefin and salts of these sulfuric acid esters.

Representative and non-limiting examples of sulfonic acid surfactants include, for example, a sulfonic acid, such as a paraffin sulfonic acid where the paraffin has from 8 to 22 carbon atoms, an alkyl benzene sulfonic acid where the alkyl group has from 4 to 28 carbon atoms, more preferably from 8 to 12 carbon atoms, a formalin condensate of an alkyl benzene sulfonic acid where the alkyl group has from 4 to 28 carbon atoms, more preferably from 8 to 12 carbon atoms, a formalin condensate of a cresol sulfonic acid, an α-olefin sulfonic acid where the alpha-olefin has from 8 to 16 carbon atoms, a dialkyl sulfo succinic acid where the alkyl group has from 4 to 28 carbon atoms, more preferably from 8 to 12 carbon atoms, a lignin sulfonic acid, a polyoxyethylene mono or di alkyl phenyl ether sulfonic acid where the alkyl group has from 4 to 28 carbon atoms, more preferably from 8 to 12 carbon atoms, a polyoxyethylene alkyl ether sulfo succinic acid half ester where the alkyl group has from 4 to 28 carbon atoms, more preferably from 8 to 18 carbon atoms, a naphthalene sulfonic acid, a mono or di alkyl naphthalene sulfonic acid where the alkyl group has from 1 to 12 carbon atoms, more preferably from 1 to 6 carbon atoms, a formalin condensate of a naphthalene sulfonic acid, a formalin condensate of a mono or di alkyl naphthalene sulfonic acid where the alkyl group has from 1 to 12 carbon atoms, more preferably from 1 to 6 carbon atoms, a formalin condensate of a creosote oil sulfonic acid, an alkyl diphenyl ether disulfonic acid where the alkyl group has from 4 to 28 carbon atoms, more preferably from 8 to 12 carbon atoms, Igepon T (product name for sodium N-oleoyl-N-methyltaurate), a polystyrene sulfonic acid, and a copolymer of a styrene sulfonic acid and methacrylic acid, and salts of these sulfonic acids.

Representative and non-limiting examples of phosphoric acid ester surfactants include a phosphoric acid ester, such as an alkyl phosphoric acid ester where the alkyl group has from 4 to 28 carbon atoms, more preferably from 8 to 12 carbon atoms, a polyoxyethylene alkyl ether phosphoric acid ester where the alkyl group has from 4 to 28 carbon atoms, more preferably from 8 to 18 carbon atoms, a polyoxyethylene mono or di alkyl phenyl ether phosphoric acid ester where the alkyl group has from 4 to 28 carbon atoms, more preferably from 8 to 12 carbon atoms, a phosphoric acid ester of a polymer of a polyoxyethylene mono, di, or tri alkyl phenyl ether where the alkyl group has from 4 to 28 carbon atoms, more preferably from 8 to 12 carbon atoms, a polyoxyethylene mono, di, or triphenyl ether phosphoric acid ester, a polyoxyethylene mono, di, or tri benzyl phenyl ether phosphoric acid ester, a polyoxyethylene mono, di, or tri styryl phenyl ether phosphoric acid ester, a phosphoric acid ester of a polymer of a polyoxyethylene mono, di, or tri styryl phenyl ether, a phosphoric acid ester of a polyoxyethylene polyoxypropylene block polymer, phosphatidylcholine, phosphatidyl ethanolimine, and a condensed phosphoric acid, such as, for example, tripoly phosphoric acid, and salts of these phosphoric acid esters.

Salts of the surfactants may comprise the above anionic materials and a counter ion. Suitable counter ions for salts of the anionic surfactants include, but are not limited to, alkaline metals, including lithium, sodium, potassium, and the like, alkaline earth metals, including calcium, magnesium, and the like, ammonium, and a variety of primary, secondary, tertiary and quaternary amines, including for example, an alkylamine, a cycloalkylamine, and an alkanol amine.

Particularly suitable surfactants include, but are not limited to, sulfonic acids. Examples include a salt of the surface active sulfonic acids used in the emulsion polymerization to form the hydroxylated polydiorganosiloxane as shown in U.S. Pat. No. 3,294,725, which is hereby incorporated by reference in its entirety. Alkali metal salts of the sulfonic acids, for example a sodium salt of a sulfonic acid may be particularly suitable for use as the surfactant. Examples of suitable sulfonic acids include, but are not limited to, substituted benzenesulfonic acids, aliphatically substituted naphthalene sulfonic acids, aliphatic sulfonic acids silylalkylsulfonic acids and aliphatically substituted diphenylethersulfonic acids.

Representative and non-limiting examples of the nonionic surfactants may include polyoxyethylene alkyl ethers, polyoxyethylene alkyl phenyl ethers, polyoxyethylene fatty acid esters, sorbitan fatty acid esters, and polyoxyethylene sorbitan fatty acid esters.

The amount of surfactant, specifically the anionic emulsifying agent and/or nonionic emulsifying agent, can be less than about 15 weight percent, based on the total weight of the total weight of the emulsion of hydroxylated polydiorganosiloxane, water, and surfactant, more specifically from about 0.1 to about 5 weight percent and even more specifically from about 0.5 to about 2 weight percent, based on the total weight of the emulsion of hydroxylated polydiorganosiloxane, water, and surfactant. This amount can result, for example, from the neutralized sulfonic acid wherein the sulfonic acid is used in the emulsion polymerization method for the preparation of the hydroxylated polydiorganosiloxane. Other anionic emulsifying agents can be used including, but not limited to, alkali metal sulfosuccinates, sulfonated glyceryl esters of fatty acids, salts of sulfonated monovalent alcohol esters, amides of amino sulfonic acid such as the sodium salt of oleyl methyl tauride, sulfonated aromatic hydrocarbon alkali salts such as sodium alpha-naphthalene monosulfonate, condensation products of naphthalene sulfonic acids with formaldehyde, and sulfates such as ammonium lauryl sulfate, triethanol amine lauryl sulfate, and sodium lauryl ether sulfate.

The first silicone emulsion comprises colloidal silica. Generally, any colloidal silica can be used. Examples of suitable colloidal silicas include, but are not limited to, fumed colloidal silicas and precipitated colloidal silicas. Particularly suitable colloidal silicas are those that are available in an aqueous medium. Colloidal silicas in an aqueous medium are typically available in a stabilized form, such as those stabilized with sodium ion, ammonia, or an aluminum ion. Aqueous colloidal silicas that have been stabilized with sodium ion are particularly useful because the pH requirement can be met by using a sodium ion stabilized colloidal silica without having to add additional ingredients to bring the pH within the range of 9 to 11.5. In one embodiment, the colloidal silica may have an average particle size of from about 5 to about 150 nanometers, from about 10 to about 125 nanometers, from about 25 nanometers to about 100 nanometers, or from about 50 to about 85 nanometers. Here as elsewhere in the specification and claims, numerical values may be combined to form new and non-disclosed ranges. Using relatively large colloidal silica particles may provide a composition with excellent shelf life stability.

In one embodiment, the average particle size for the colloidal silica is determined in accordance with ASTM E2490-09 (2015), Standard Guide for Measurement of Particle Size Distribution of Nanomaterials in Suspension by Photon Correlation Spectroscopy (PCS).

The first silicone emulsion with the colloidal silica has a continuous water phase in which there is a dispersed phase which comprises an anionically stabilized hydroxylated polydiorganosiloxane, emulsion stabilizer, catalyst, surfactant and colloidal silica. The use of relatively large silica particles has been found to provide a composition with good shelf life and storage stability. In one embodiment, the pH of the crosslinkable silicone-based emulsion should be within the range of 7 to 12, more preferably from 9 to 11.5 inclusive, which may also provide or contribute to the shelf life and storage stability of the composition. In another embodiment, the composition has a pH in the range of 10.5 to 11.5.

In one embodiment, the pH of the crosslinked silicone emulsion is determined in accordance with ASTM E70-07 (2015), Standard Test Method for pH of Aqueous Solutions with the Glass Electrode.

The first silicone emulsion with colloidal silica comprises water in an amount of from about 20 to about 99 percent by weight of the based on the total weight of the water, hydroxylated polydiorganosiloxane, surfactant, silica, catalyst and emulsion stabilizer of the crosslinkable silicone emulsion and a dispersed phase comprising the hydroxylated polydiorganosiloxane, colloidal silica, surfactant, catalyst and emulsion stabilizer in an amount of from about 1 to about 80 percent by weight of the based on the total weight of the water, hydroxylated polydiorganosiloxane, surfactant, silica, catalyst and emulsion stabilizer of the crosslinkable silicone emulsion. In one embodiment, the water is from about 30 to about 90 percent by weight and the dispersed phase is from about 10 to about 70 percent by weight of the based on the total weight of the water, hydroxylated polydiorganosiloxane, surfactant, silica, catalyst, and emulsion stabilizer of the first silicone emulsion. In another embodiment, the water is from about 40 to about 80 percent by weight of the based on the total weight of the water, hydroxylated polydiorganosiloxane, surfactant, silica, catalyst, and emulsion stabilizer of the first silicone emulsion, and the dispersed phase is from about 20 to about 60 percent by weight of the based on the total weight of the water, hydroxylated polydiorganosiloxane, surfactant, silica, catalyst, and emulsion stabilizer of the first silicone emulsion.

The colloidal silica may be present in an amount of from about 1 to about 150 parts by weight of colloidal silica per 100 parts by weight of the hydroxylated polydiorganosiloxane, from about 5 to about 125 parts by weight of colloidal silica per 100 parts by weight of hydroxylated polydiorganosiloxane, from about 10 to about 100 parts by weight of colloidal silica per 100 parts by weight of hydroxylated polydiorganosiloxane, or from about 25 to about 70 parts by weight of colloidal silica for each 100 parts by weight of hydroxylated polydiorganosiloxane. In one embodiment, the colloidal silica is present in an amount of from about 5 wt. % to about 50 wt. % based on the weight of the first emulsion; from about 7.5 wt. % to about 40 wt. %, from about 10 wt. % to about 30 wt. %, or from about 15 wt. % to about 25 wt. % based on the total weight of the first emulsion.

The first silicone emulsion may comprise an emulsion stabilizer. The emulsion stabilizer is not particularly limited and may be selected as desired for a particular purpose or intended application. In one embodiment, the emulsion stabilizer is chosen from an alkanolamine. Examples of suitable alkanolamines for the emulsion stabilizer include, but are not limited to, 2-amino-2-methyl-1-propanol (AMP), 2-amino-1-butanol, 2-amino-2-methyl-1,3-propanediol, 2-amino-2-ethyl-1,3-propanediol, 2-amino-2-hydroxymethyl-1,3-propanediol and N-methyl or N-ethyl derivative thereof and N,N-dimethyl or N,N-diethyl derivatives thereof. Also included are the ethanolamines and propanolamines and N-substituted alkyl, specifically methyl or ethyl derivatives thereof. In an embodiment, AMP is particularly suitable as the emulsion stabilizer.

The amount of emulsion stabilizer may range from about 0.1 to about 10 weight percent, from about 0.5 to about 5 weight percent, from about 1 to about 3 weight percent, based on the total weight of the water, hydroxylated polydiorganosiloxane, surfactant, silica, catalyst, and emulsion stabilizer of the first silicone emulsion.

The first silicone emulsion with colloidal silica comprises one or more catalysts. In an embodiment, the catalyst may be emulsified using non-ionic or anionic surfactants. Suitable catalysts include both metal and non-metal catalysts. Examples of the metal portion of the metal condensation catalysts useful in the present invention include tin, titanium, zirconium, lead, iron cobalt, antimony, manganese, bismuth, and zinc compounds. Other suitable non-limiting examples of catalysts are well known in the art and include chelates of various metals such as those which can be obtained from acetylacetone, benzoylacetone, trifluoroacetylacetone, ethyl acetoacetate, salicylaldehyde, cyclopentanone-2-carboxylate, acetylacetoneimine, bis-acetylaceone-alkylenediimines, salicylaldehydeimine, and the like, with the various metals such as Al, Be, Mg, Zn, Cd, Pb, Ti, Zr, Sn, As, Bi, Cr, Mo, Mn, Fe, Co, Ni, and metal oxide ions as MoO₂⁺⁺, UO₂⁺⁺, and the like; alcoholates and phenolates of various metals such as Ti(OR)₄, Sn(OR)₄, Sn(OR)₂, Al(OR)₃, Bi(OR)₃ and the like, wherein R is alkyl or aryl of from 1 to about 18 carbon atoms, and reaction products of alcoholates of various metals with carboxylic acids, beta-diketones, and 2-(N,N-dialkylamino)alkanols, such as well-known chelates of titanium obtained by this or equivalent procedures. Further catalysts include organometallic derivatives of tetravalent tin, trivalent and pentavalent As, Sb, and Bi, and metal carbonyls of iron and cobalt; and combinations thereof. In one embodiment, organotin compounds that are dialkyltin salts of carboxylic acids, can include the non-limiting examples of dibutyltin diacetate, dibutyltin dilaurate, dibutyltin maleate, dilauryltin diacetate, dioctyltin diacetate, dioctyltin dineo-decanoate, dibutyltin-bis(4-methylaminobenzoate), dibutyltindilaurylmercaptide, dibutyltin-bis(6-methylaminocaproate), and the like, and combinations thereof. Similarly, in another embodiment there may be used trialkyltin hydroxide, dialkyltin oxide, dialkyltin dialkoxide, or dialkyltin dichloride and combinations thereof. Non-limiting examples of these compounds include trimethyltin hydroxide, tributyltin hydroxide, trioctyltin hydroxide, dibutyltin oxide, dioctyltin oxide, dilauryltin oxide, dibutyltin-bis(isopropoxide), dibutyltin-bis(2-dimethylaminopentylate), dibutyltin dichloride, dioctyltin dichloride, and the like, and combinations thereof.

Emulsions of the catalyst are prepared using non-ionic or anionic surfactants, water and the catalysts, by methods known in the art. The emulsion of the catalysts comprises from about 0.1 to about 10 weight percent of surfactant, and in embodiments from about 1 to about 3 weight percent surfactant and from about 1 to about 75 weight percent, and in embodiments from about 25 to about 70 weight percent catalyst and the remainder to make up 100 weight percent of the emulsion is water.

In the first silicone emulsion, the amount of catalyst is from about 0.01 to about 10 weight percent, from about 0.1 to about 5 weight percent, or from about 1 to about 3 weight percent, based on the total weight of the water, hydroxylated polydiorganosiloxane, surfactant, silica, catalyst and emulsion stabilizer of the crosslinkable silicone emulsion.

In one embodiment, the crosslinkable silicone emulsion is prepared by
(a) providing a first non-ionically or anionically stabilized emulsion of the hydroxylated polydiorganosiloxane;
(b) adding colloidal silica, emulsion of the catalyst and emulsion stabilizer to the first emulsion of step (a) to form a second emulsion; and
(c) heating the second emulsion of step (b) to provide for a crosslinkable silicone emulsion.

The non-ionically or anionically stabilized emulsion of the hydroxylated polydiorganosiloxane may be prepared in any suitable manner. For example, emulsified hydroxylated polydiorganosiloxane may be prepared by emulsion polymerization of a polydiorganocyclosiloxane with an anionic polymerization catalyst to provide a hydroxylated polydiorganosiloxane comprising an anionic surfactant. Other methods of providing an anionically stabilized hydroxylated polydiorganosiloxane comprise emulsifying a hydroxylated polydiorganosiloxane using an anionic surfactant.

The colloidal silica may be added to the non-ionically or anionically stabilized emulsion of the hydroxylated polydiorganosiloxane as a dry powder, an aqueous dispersion, or a combination thereof. In one embodiment, the colloidal silica is added as an aqueous dispersion. In particular, in another embodiment, the colloidal silica is added as a dispersion that is anionically stabilized. The colloidal silica may be anionically stabilized with any suitable surfactant, including those suitable for stabilizing the hydroxylated polydiorganosiloxane.

The emulsion of non-ionically or anionically stabilized emulsion of the hydroxylated polydiorganosiloxane, emulsion stabilizer, emulsion of the catalyst and colloidal silica is then heated to provide for the crosslinkable silicone emulsion. The emulsion is then heated at a temperature of from about 40° C. to about 100° C. for about 1 to 72 hours. In another embodiment, the second emulsion is heated at a temperature of from about 65° C. to about 90° C., more specifically from about 70° C. to about 85° C. and even more preferably of about 80° C. for 2 to 24 hours.

### Aminosilicone Emulsion

The silicone emulsion composition also comprises an aminosilicone emulsion. The aminosilicone emulsion can be any siloxane or silicone fluid comprising an amine-functional group terminal or pendant to the siloxane backbone.

The aminosilicone can be formed in any suitable manner. In embodiments, the aminosilicone can be formed from the reaction of a hydroxylated polyorganosiloxane and an aminosilane in the presence of a catalyst, and the aminosilicone can be emulsified with a surfactant. In embodiments, the aminosilicone emulsion can be formed in situ by catalytic ring opening of a cyclic siloxane in the presence of a surfactant and the addition of an aminosilane to cap the polymer.

In embodiments, the aminosilicone can be prepared by the base catalyzed reaction of a hydroxylated polydiorganosiloxane and an aminofunctional silane (an aminosilane). The term “hydroxylated polydiorganosiloxane” suitable for use to form the aminosilicone includes, but is not limited to, polymers that are essentially a linear species of repeating diorganosiloxane units and polymeric species that contain small numbers of monoorganosiloxane units, up to a maximum of about five monoorganosiloxane unit per 100 diorganosiloxane units, more preferably one monoorganosiloxane unit per 100 diorganosiloxane units. The hydroxylated polydiorganosiloxanes may have an average of about two silicon-bonded hydroxyls per molecule up to a number of silicon-bonded hydroxyls that is equal to one silicon-bonded hydroxyl for each monoorganosiloxane in the hydroxylated polydiorganosiloxane molecule plus the two chain-terminating silicon-bonded hydroxyls. In embodiments, the hydroxylated polydiorganosiloxane comprises about two silicon-bonded hydroxyls per molecule.

Suitable hydroxylated polydiorganosiloxanes are those which have an elastomeric property when the hydroxylated polydiorganosiloxanes are reacted with the colloidal silica and after the removal of the water from the emulsion. In one embodiment, the hydroxylated polydiorganosiloxane has a weight average molecular weight (Mw) of at least about 250. In one embodiment, the hydroxylated polydiorganosiloxane used for the aminosilicone emulsion has a weight average molecular weight of from about 250 to about 1,000,000, from about 500 to about 750,000, from about 1,000 to about 500,000, from about 2,500 to about 250,000, from about 5,000 to about 100,000, or from about 10,000 to about 50,000. In one embodiment, the hydroxylated polydiorganosiloxane for the aminosilicone emulsion has a weight average molecular weight of from about 5,000 to about 1,000,000, from about 100,000 to about 1,000,000, from about 200,000 to about 1,000,000, or from about 500,000 to about 1,000,000. In embodiments, the weight average molecular weights for the hydroxylated polydiorganosiloxane containing at least one monoorganosiloxane unit is in the range of about 100,000 to about 1,000,000, from about 200,000 to about 700,000, even more preferably from about 400,000 to about 600,000. In still another embodiment, the hydroxylated polydiorganosiloxane for the aminosilicone has a weight average molecular weight of from about 250 to about 5,000, from about 500 to about 4,000, from about 750 to about 2,500, or from about 1,000 to about 2,000. Weight average molecular weight can be determined by ASTM D5296-11.

In another embodiment, the weight average molecular weight for the hydroxylated polydiorganosiloxane, including the hydroxylated polydiorganosiloxane containing at least one monoorganosiloxane unit is determined in accordance with ASTM D5296-11, Standard Test Method for Molecular Weight Averages and Molecular Weight Distribution of Polystyrene by High Performance Size-Exclusion Chromatograph.

In still another embodiment, the hydroxylated polydiorganosiloxane is a compound having the structure of Formula (1):

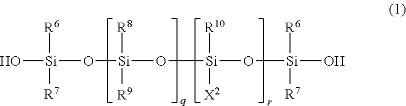

wherein:
each occurrence of R⁶ and R⁷ is independently selected from the group consisting of a hydroxyl group, an alkyl group having from 1 to 10 carbon atoms, an alkyl group having from 1 to 10 carbon atoms and substituted with at least one fluoro group, an aryl group having from 6 to 10 carbon atoms, a cycloalkyl group having from 3 to 10 carbon atoms, an alkenyl group containing 2 to 10 carbon atoms and an aralkyl group having from 7 to 12 carbon atoms, more preferably R⁶ and R⁷ are independently chosen from methyl, ethyl, or phenyl, and even more preferably methyl;
each occurrence of R¹, R⁹, and R¹⁰ is independently selected from the group consisting of an alkyl group having from 1 to 10 carbon atoms, an alkyl group having from 1 to 10 carbon atoms and substituted with at least one fluoro group, an aryl group having from 6 to 10 carbon atoms, a cycloalkyl group having from 3 to 10 carbon atoms, an alkenyl group containing 2 to 10 carbon atoms and an aralkyl group having from 7 to 12 carbon atoms, more preferably each occurrence of R¹, R⁹, and R¹⁰ is independently selected from methyl, ethyl, or phenyl, and even more preferably methyl;
each occurrence of X² is independently a group having the structure of Formula (2):

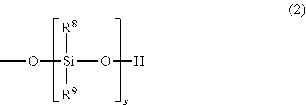

wherein each occurrence of R⁸ and R⁹ is independently selected from the group consisting of an alkyl group having from 1 to 10 carbon atoms, an alkyl group having from 1 to 10 carbon atoms and substituted with at least one fluoro group, an aryl group having from 6 to 10 carbon atoms, a cycloalkyl group having from 3 to 10 carbon atoms, an alkenyl group containing 2 to 10 carbon atoms and an aralkyl group having from 7 to 12 carbon atoms, more preferably each occurrence of R³ and R⁴ in Formula (2) is independently chosen from methyl, ethyl, or phenyl, and even more preferably methyl;
wherein the subscript q, r, and s are integers independently chosen such that the weight average molecular weight of the material has a weight average molecular weight satisfying the values or the ranges described above. In another embodiment, q, r, and s are integers, wherein q is from about 65 to about 13,500, r is from 0 to about 135, s is from 0 to about 1,000, q is from 130 to 10,000, r is from 0 to 13 and s is from 0 to about 100, q is from about 325 to 2,700, r is from 0 to about 5 and s is from 0 to 10; or q is from about 650 to 1,350, r is 0 or 1 and s is 0, with the provisos that
(iii) the molar ratio of q:r is from 100:0 to 100:5, more preferably, from 100:0 to 100:1 and even more preferably 100:0, and
(iv) the sum of q+r+s is from 65 to 13,500.

The organic groups of the hydroxylated polydiorganosiloxane can be monovalent alkyl groups containing less than seven carbon atoms and 2-(perfluoroalkyl)ethyl groups containing less than seven carbon atoms. Representative and non-limiting alkyl groups include methyl, ethyl, propyl, butyl, isopropyl, pentyl, and hexyl. Representative and non-limiting examples of alkenyl groups include vinyl and allyl. Representative and non-limiting examples of cycloalkyl groups include cyclopentyl, cyclohexyl, cyclooctyl, and cyclodecyl. Representative and non-limiting examples of aryl groups are phenyl and tolyl; and non-limiting examples of aralkyl groups are benzyl or phenethyl. Representative and non-limiting examples of 2-(perfluoroalkyl)ethyl groups include 3,3,3-trifluoropropyl and 2-(perfluorobutyl)ethyl. In still another embodiment, the hydroxylated polydiorganosiloxanes may contain organic groups in which at least 50 mole percent are methyl. In one embodiment, the hydroxylated polydiorganosiloxnes is a hydroxyl-terminated polydimethylsiloxane.

The aminosilane can be selected from a compound of the formula:

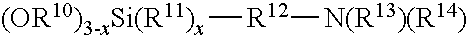

where R¹⁰ is a C1-C8 alkyl;
R¹¹ is selected from H, a C1-C12 alkyl, or C3-C10 cycloalkyl, or a C6-C30 aromatic containing group;
R¹² is selected from a C1-C12 alkylene;
R¹³ and R¹⁴ are independently selected from H, a C1-C12 alkyl, or —R¹⁵—N(R¹⁶)(R¹⁷), where R¹⁵ is a C1-C12 alkylene, R¹⁶ and R¹⁷ are independently selected from H and a C1-C12 alkyl; and
x is 0, 1, or 2.

Examples of suitable aminosilanes include, but are not limited to, aminopropyltrimethoxysilane, aminopropyltrimethoxysilane, aminobutyltriethoxysilane, aminoethylaminoisobutylmethyldiethoxysilane, p-aminophenyltrimethoxysilane, N-(2-aminoethyl-3-aminopropyl)triethoxysilane, aminoundecyltrimethoxysilane, and aminopropylmethyldiethoxysilane, phenylaminopropyltriemthoxy silane, methylaminopropyltriemthoxysilane, n-butylaminopropyltrimethoxy silane, t-butyl aminopropyltrimethoxysilane, N-methyl-3-amino-2-methylpropyltriemthoxysilane, N-ethyl-3-amino-2-methylpropyltrimethoxysilane, N-ethyl-3-amino-2-methylpropyidiethoxysilane, N-ethyl-3-amino-2-methylpropyoltriethoxysilane, N-ethyl-3-amino-2-methylpropylmethyidimethoxysilane, N-butyl-3-amino-2-methylpropyltriemthoxysilane, 3-(N-methyl-3-amino-1-methyl-1-ethoxy)propyltrimethoxysi lane, N-ethyl-4-amino-3,3-dimethylbutyidimethoxymethylsilane and N-ethyl-4-amino-3,3-dimethylbutyltrimethoxysilane, N-cyclohexylaminopropyltrimethoxysilane, bis(trimethoxysilylpropyl)amine, bis((3-trimethoxysilyl)propyl)-ethylenediamine, and the like.

The aminosilane is provided such that the aminosilicone emulsion has an amine content of from about 0.01 wt. % to about 10 wt. %, from about 0.05 wt. % to about 8 wt. %, from about 0.1 wt. % to about 6 wt. %, from about 0.25 wt. % to about 5 wt. %, from about 0.5 wt. % to about 2.5 wt. %, or from about 1 wt % to about 2 wt. % based on the weight of the aminosilicone. The amine content is the total amine content within the molecule, including but not limited to amines in the form of NH₂, NR₂, NH, and/or NR.

The catalyst for forming the aminosilicone can be selected from, for example, a base catalyst. Suitable base catalysts include, but are not limited to, strong alkalis such as, for example, potassium hydroxide, sodium hydroxide, tetraallyl ammonium hydroxide, and the like. In one embodiment, the catalyst may be selected from potassium hydroxide.

In embodiments, the aminosilicone can be formed from the ring opening polymerization of a cyclic siloxane. Cyclic siloxanes are useful and commercially available materials. They have the general formula (R²¹R²²SiO)ₙ, wherein R²¹ and R²² are independently chosen from an alkyl, alkenyl, aryl, alkaryl, or aralkyl group having up to 8 carbon atoms, which may be unsubstituted or substituted, and n denotes an integer with a value of from 3 to 12. R²¹ and R²² can be substituted, e.g., by halogen such as fluorine or chlorine. The alkyl group can be, for example, methyl, ethyl, n-propyl, trifluoropropyl, n-butyl, sec-butyl, and tert-butyl. The alkenyl group can be, for example, vinyl, allyl, propenyl, and butenyl. The aryl and aralkyl groups can be, for example, phenyl, tolyl, and benzoyl. In one embodiment, at least 80% of all R²¹ and R²² groups are methyl or phenyl groups. In one embodiment, substantially all R²¹ and R²² groups are methyl groups. Where R²¹ and R²² are methyl, the compound is referred to as Dn; for example, where n=4 the compound is called D4. The value of n can be from 3 to 6, and in one embodiment is 4 or 5. Examples of suitable cyclic siloxanes are octamethyl cyclotetrasiloxane (D4), hexamethylcyclotrisiloxane (D3), octaphenylcyclotetrasiloxane, tetramethylcyclotetrasiloxane, tetramethyltetravinylcyclotetrasiloxane, hexamethyl-1,1-diphenylcyclotetrasiloxane, decamethyl pentacyclosiloxane, cyclopenta (methylvinyl) siloxane, and cyclotetra(phenylmethyl) siloxane. One particularly suitable commercially available material is a mixture of octamethylcyclo-tetrasiloxane and decamethylcyclopentasiloxane.

Suitable ring opening catalysts include, but are not limited to, metal hydroxides, alkali metal alkoxides or complexes of alkali metal hydroxides and an alcohol, alkali metal silanolates, and phosphonitrile halides (sometimes referred to as acidic phosphazenes). In embodiments, the ring opening catalyst is potassium hydroxide.

The amino silicone emulsion is formed by emulsification in a surfactant. The surfactant can be selected from a nonionic surfactant, a cationic surfactant, an anionic surfactant, or mixture of two or more thereof. Examples of suitable nonionic surfactants include, but are not limited to, ethyoxylated aliphatic alcohols, fats, oils and waxes, carboxylic esters, and the like. Some examples include, but are not limited to, polyoxyethylene alkyl ethers, polyoxyethylene alkyl phenyl ethers, polyoxyethylene fatty acid esters, sorbitan fatty acid esters, polyoxyethylene sorbitan fatty acid ester, polyethylene glycols, and the like. In one embodiment, the nonionic surfactant is selected from a C6-C24 alcohol ethoxylate comprising from 5 to 30 ethylene oxide units per molecule.

The cationic surfactant can be selected as desired to help form the aminosilicone emulsion. Suitable cationic surfactants and include, for example, quaternary ammonium salts, including ethoxylated quaternary ammonium salts and quaternary ammonium esters. Suitable quaternary ammonium salts include, for example, dialkyldimethylammonium salts, alkyldimethylammonium salts, alkyltrimethyl ammonium salts. Suitable ethoxylated quaternary ammonium salts include, for example, N,N,N′,N′,N′-pentamethyl-N-tallow-1,3-propoanediammonium dichloride. Suitable quaternary ammonium esters include, for example, N,N-di(tallowyl-oxy-ethyl)-N,N-dimethyl ammonium chloride.

In one embodiment, the surfactant comprises a cationic surfactant selected from quaternary ammonium salts, more preferably an alkyltrimethyl ammonium salt, even more preferably a (C₈-C₂₀)alkyltrimethyl ammonium chloride.

The aminosilicone emulsion can be prepared in any suitable manner. In one embodiment, a polyorganosiloxane, a surfactant, and an acid or base catalyst, and water are combined in a reaction vessel, homogenized and heated to form a hydroxy end-stopped polyorganosiloxane. An aminosilane is then added to the reaction mixture and heated to drive condensation of the hydroxy end-stopped polyorganosiloxane and aminofunctional silane to form an aminofunctional silicone polymer. Following the condensation reaction, the catalyst is neutralized. It will be appreciated that, alternatively, the reaction can be conducted in one step by acid or base catalyzed equilibration of a cyclic polyorganosiloxane in an aqueous medium in the presence of surfactant and an aminofunctional silane.

The waterborne silicone emulsion composition may comprise other components as may be desired for a particular purpose or intended application. Such components may include, but are not limited, fillers, such as, for example, calcium carbonate, talc, mica, barium sulfate, silica, clays or a combination of two or more thereof; pigments; dispersing; wetting agents, such as, for example, silicone polyether copolymer; defoamers such as, for example, acetylenic diols, mineral oils and silicones; plasticizers; associative thickeners for rheology control; waxes; colorants; antioxidants; UV stabilizers; biocides; wet-adhesive emulsion additives; coalescing agents such as, for example, texanol, butyl carbinol, hexylene glycol, ethylene glycol monobutyl ether, adipic, phthalic and benzoic acid esters of propane diol and propylene glycol ether; additives for pH control; functional silanes/silicones such as, for example, epoxy-functional polysiloxanes, or a combination of two or more thereof.

The emulsion can include a pigment to provide the coating with a desired color or appearance. Examples of suitable pigments include, but are not limited to, titanium dioxide, black iron oxide, red iron oxide, transparent red oxide, yellow iron oxide, transparent yellow oxide, brown iron oxide (a blend of red and yellow oxide with black), zinc oxide, magnesium silicates, calcium carbonate, aluminosilicates, silica and various clays, carbon black, lampblack, greens such as phthalocyanine green, blues such as phthalocyanine blue, reds (such as naphthol red, quinacridone red, toulidine red and DPP red, also known as PR254), magentas such as quinacridone magenta, violets (such as quinacridone violet and carbazole violet), oranges (such as DNA orange and DPP orange), yellows (such as monoazo yellow and bismuth vanadate yellow), umber, complex inorganic color pigments (also known as CICPs), and the like. The emulsion can include a mixture of different pigments. The pigment particles can have a shape selected from a regular sphere, an oblate sphere, a prolate sphere, an irregular sphere, a cube, a rhombus, plates, an irregular shape, and the like. The pigments can include mixtures of particles of different shapes. The amount of pigment may be selected to provide a desired color or appearance.

Exemplary thickeners and other rheology modifiers include sedimentation inhibitors, hydrophobic ethoxylated urethane resin (HEUR) thickeners, hydrophobically-modified, alkali-soluble or alkali-swellable emulsion (HASE) thickeners), cellulosic thickeners, polysaccharide thickeners and mixtures thereof. Exemplary commercially-available rheology modifiers include NATROSOL™ 250 and the AQUAFLOW™ series from Ashland, ATTAGEL™ 50 from BASF Corp., the CELLOSIZE™ series and UCAR POLYPHOBE™ T-900 and T-901 from Dow Chemical Co., BENTONE™ AD and BENTONE EW from Elementis Specialties, LATTICE™ NTC-61 from FMC Biopolymer and ACRYSOL™ RM-6, ACRYSOL RM-8, ACRYSOL RM-12W and ACRYSOL RM-2020NPR all from Rohm & Haas. The chosen rheology modifier types and amounts may vary widely and normally will be empirically determined using techniques that will be familiar to persons having ordinary skill in the art.

Examples of pigment dispersing agents include, but are not limited to, various nonionic (e.g., ethoxylated) and anionic (e.g., non-ethoxylated salt) forms including agents from Air Products and Chemicals, Inc. (e.g., SURFYNOL™ PSA336); Archer Daniels Midland Co. (e.g., ULTRALEC™ F deoiled lecithin); Ashland Inc. (e.g., NEKAL™ WS-25-I, which is a sodium bis(2,6-dimethyl 4heptyl)sulfosuccinate); BASF (e.g., DISPEX™ AA 4144, DISPEX ULTRA FA 4425 which is a fatty acid-modified emulsifier having a viscosity of 40,000 cps, DISPEX ULTRA FA 4420 which is a fatty acid-modified emulsifier and a dark brown liquid of unspecified viscosity, DISPEX ULTRA FA 4431 which is an aliphatic polyether with acidic groups having a viscosity of 350 cps, DISPEX ULTRA PA 4501 which is a fatty acid modified polymer having a viscosity of 10,000 cps, DISPEX ULTRA PA 4510, EFKA™ PU 4010, EFKA PU 4047 which is a modified polyurethane, EFKA PX 4300, EFKA ULTRA PA 4510 and EFKA ULTRA PA 4530 which are modified polyacrylates, EFKA FA 4620 which is an acidic polyether having a viscosity of 1,400 cps, EFKA FA 4642 which is an unsaturated polyamide and acid ester salt having a viscosity of 2,000 cps, HYDROPALAT™ WE 3135, HYDROPALAT WE 3136 and HYDROPALAT WE 3317 which are difunctional block copolymer surfactants terminating in primary hydroxyl groups and having respective viscosities of 375, 450 and 600 cps, and TETRONIC™ 901 and TERTRONIC 904 which are tetrafunctional block copolymers terminating in primary hydroxyl groups and having respective viscosities of 700 and 320 cps); and the like.

The silicone emulsion can be prepared by mixing the emulsion of the silicone with grafted silica (first silicone emulsion) and the amino silicone emulsion (second silicone emulsion). The silicone emulsion can be provided to have an active weight ratio of the first silicone emulsion to the second silicone emulsion from about 90:10 to about 10:90 based on the total weight of the first and second emulsion, an active weight ratio of the first silicone emulsion to the second silicone emulsion from about 80:20 to about 20:80 based on the total weight of the first and second emulsion, an active weight ratio of the first silicone emulsion to the second silicone emulsion from about 70:30 to about 30:70 based on the total weight of the first and second emulsion, or an active weight ratio of the first silicone emulsion to the second silicone emulsion from about 60:40 to about 40:60 based on the total weight of the first and second emulsion. In one embodiment, the emulsion has an active weight ratio of the first silicone emulsion to the second silicone emulsion from about 60:40 to about 90:10 based on the total weight of the first and second emulsion, an active weight ratio of the first silicone emulsion to the second silicone emulsion from about 70:30 to about 85:15 based on the total weight of the first and second emulsion, or an active weight ratio of the first silicone emulsion to the second silicone emulsion from about 75:25 to about 80:20 based on the total weight of the first and second emulsion. It will be appreciated that the “active weight” refers to the active solids in the respective emulsions.

In one aspect, a coating composition is provided comprising the silicone emulsion. The coating composition may include other components such as a binder resin, polysiloxane resins, diluents, solvents (aqueous or non-aqueous), pigments, fillers, dispersing agents, wetting agents, defoamers, plasticizers, thickeners, waxes; colorants; antioxidants; UV stabilizers; biocides; coalescing agents; pH control additives; or combinations of two or more thereof.

In one embodiment, the coating composition further comprises a binder resin. The binder resin may be selected from an organic resin. The organic resin is not particularly limited and can be chosen as desired for a particular purpose or intended application.

In one embodiment, the organic resin is a waterborne organic resin. In another embodiment, the waterborne organic resin comprises a latex polymer formed by emulsion polymerization of at least one ethylenically unsaturated monomer in water using surfactants and water soluble initiators. Typical ethylenically unsaturated monomers include vinyl monomers, acrylic monomers, acrylate monomers, methacrylic monomers, methacrylate monomers, acid-functional monomers, allylic monomers and acrylamide monomers. For architectural applications, the waterborne organic resin(s) may be formed from vinyl monomers and/or acrylic monomers. Suitable vinyl monomers include vinyl esters, vinyl aromatic hydrocarbons, vinyl aliphatic hydrocarbons, vinyl alkyl ethers, or a mixture of two or more thereof. Examples of vinyl esters that may be used include, but are not limited to, vinyl acetate, vinyl propionate, vinyl laurate, vinyl pivalate, vinyl nonanoate, vinyl decanoate, vinyl neodecanoate, vinyl butyrates, vinyl benzoates, vinyl isopropyl acetates, or a combination or two or more thereof. Examples of vinyl aromatic hydrocarbons that may be used include, but are not limited to, styrene, methyl styrenes and other lower alkyl styrenes, chlorostyrene, vinyl toluene, vinyl naphthalene, divinyl benzene, or a combination of two or more thereof. Examples of vinyl aliphatic hydrocarbons that may be used include, but are not limited to, vinyl chloride and vinylidene chloride as well as alpha olefins such as ethylene, propylene, isobutylene, hexylene and octylene, as well as conjugated dienes such as, but not limited to, 1,3 butadiene, methyl-2-butadiene, 1,3-piperylene, 2,3-dimethyl butadiene, isoprene, cyclohexadiene, cyclopentadiene and dicyclopentadiene. Examples of vinyl alkyl ethers that may be used include, but are not limited to, methyl vinyl ether, isopropyl vinyl ether, n-butyl vinyl ether and isobutyl vinyl ether. Acrylic monomers suitable for use in the present invention include any compounds having acrylic functionality such as, but not limited to, alkyl acrylates, acrylic acids, as well as aromatic derivatives of acrylic acid, acrylamides and acrylonitrile. Methacrylic monomers suitable for use in the present invention include any compounds having methacrylic functionality such as, but not limited to, alkyl methacrylates, methacrylic acids, as well as aromatic derivatives of methacrylic acid and methacrylamides. Typically, the alkyl acrylate monomers (also referred to herein as “alkyl esters of acrylic acid”) and methacrylate monomers (also referred to herein as “alkyl esters of methacrylic acid”) will have an alkyl group containing from 1 to 12, preferably about 1 to 5, carbon atoms per molecule.

Suitable acrylic monomers include, but are not limited to, methyl acrylate, ethyl acrylate, butyl acrylate, propyl acrylate, 2-ethyl hexyl acrylate, decyl acrylate, isodecyl acrylate and neopentyl acrylate. Aryl acrylate monomers include phenyl acrylate and tolyl acrylate. Aralkyl acrylate monomers include benzyl acrylate and phenethyl acrylate. Cycloalkyl acrylate monomers include cyclohexyl acrylate, isobornyl acrylate, 1-adamatyl acrylate. Various reaction products such as butyl, phenyl, and cresyl glycidyl ethers reacted with acrylic acid, hydroxyl alkyl acrylates, such as hydroxyethyl and hydroxypropyl acrylates, amino acrylates, as well as acrylic acids such as acrylic acid, ethacrylic acid, alpha-chloroacrylic acid, alpha-cycanoacrylic acid, crotonic acid, beta-acryloxy propionic acid, and beta-styryl acrylic acid can be used as monomers.

Suitable methacrylic monomers include, but are not limited to, methyl methacrylate, ethyl methacrylate, butyl methacrylate, propyl methacrylate, 2-ethyl hexyl methacrylate, decyl methacrylate, isodecyl methacrylate and neopentyl methacrylate. Aryl methacrylate monomers include phenyl methacrylate and tolyl methacrylate. Aralkyl methacrylate monomers include benzyl methacrylate and phenethyl methacrylate. Cycloalkyl methacrylate monomers include cyclohexyl methacrylate, isobornyl methacrylate, 1-adamatyl methacrylate. Various reaction products such as butyl, phenyl, and cresyl glycidyl ethers reacted with methacrylic acid, hydroxyl alkyl methacrylates, such as hydroxyethyl and hydroxypropyl methacrylates, amino methacrylates, as well as methacrylic acids such as methacrylic acid, and beta-styryl methacrylic acid can be used as monomers.

The organic resin emulsion may be prepared using any of the well-known free-radical emulsion polymerization techniques used to formulate latex polymers. Polymerization techniques suitable for use herein are disclosed in U.S. Pat. No. 5,486,576, which is incorporated herein by reference in its entirety.

In one embodiment, the organic resin emulsion is a latex polymer emulsion. Conventional latex emulsions include those prepared by polymerizing at least one ethylenically unsaturated monomer in water using surfactants and water-soluble initiators. Typical ethylenically unsaturated monomers include vinyl monomers, acrylic monomers, allylic monomers, acrylamide monomers and mono- and dicarboxylic unsaturated acids. Suitable vinyl esters include, but are not limited to, vinyl acetate, vinyl propionate, vinyl butyrates, vinyl isopropyl acetates, vinyl neodeconate and similar vinyl esters; vinyl halides include vinyl chloride, vinyl fluoride and vinylidene chloride; vinyl aromatic hydrocarbons include styrene, α-methyl styrene, and similar lower alkyl styrenes. Suitable acrylic monomers include monomers such as lower alkyl esters of acrylic or methacrylic acid having an alkyl ester portion containing between 1 to 12 carbon atoms as well as aromatic derivatives or acrylic and methacrylic acid. Useful acrylic monomers include, but are not limited to, for example, acrylic and methacrylic acid, methyl acrylate and methacrylate, ethyl acrylate and methacrylate, butyl acrylate and methacrylate, propyl acrylate and methacrylate, 2-ethyl hexyl acrylate and methacrylate, cyclohexyl acrylate and methacrylate, decyl acrylate and methacrylate, isodecylacrylate and methacrylate, and benzyl acrylate and methacrylate.

Other organic resin emulsions useful as a binder include polyurethane emulsions, polyester emulsions and epoxy emulsions.

The organic resin emulsion comprises from about 25 to 99 weight percent water and from about 1 to about 75 weight percent organic resin and surfactant, more preferably from about 30 to about 75 weight percent water and from about 25 to about 70 weight percent organic resin and surfactant, wherein the weight percents are based upon the total weight of the organic resin, surfactant and water.

In embodiments where the composition comprises an organic resin in addition to the present silicone emulsion composition, the organic resin may be present in an amount of from about 0.01 wt. % to about 99.99 wt. %, from about 3 wt. % to about 90 wt. %, or from about 10 wt. % to about 70 wt. % based on the total weight of the coating composition.

In certain embodiments, the coating compositions of the present invention may comprise a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coating compositions of the present invention. Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coating compositions by use of a grind vehicle, such as an acrylic grind vehicle, the use of which will be familiar to one skilled in the art.

In embodiments, the coating composition comprises a pigment. The pigment is not particularly limited and can be selected as desired to impart a coating with a particular appearance. Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

In embodiments, the coating composition can have a pigment volume concentration of about 65% or greater, about 70% or greater, about 75% or greater, about 80% or greater or about 85% or greater. In one embodiment, the coating composition can have a pigment volume concentration of from about 65% to about 90%, from about 70% to about 85%, or from about 75% to about 80%.

The silicone emulsion or compositions comprising the silicone emulsion may be used to provide a film, coating, or article. The films or coatings can be applied by spray techniques, brushed onto substrates, applied with fiber-based rollers, applied using roll coating equipment and the like. Articles can be prepared by casting the compositions and subjecting them to curing. The substrates to which the coatings of this invention can be applied include wood-based, plasterboard, cement, wallpaper, previously coated surfaces, stucco, leather, plastic-based surfaces, plastic film, paper, cardboard, metal, and the like. The coatings are suitable for use in both interior and exterior applications. The coatings or materials formed from the present emulsions can also be used in environments requiring resistance from UV, water, stains, chemicals, heat or fire.

In embodiments, the materials formed from the emulsions can exhibit high thermal degradation and/or good thermal conductivity and/or excellent durability.

The following examples are presented for purposes of illustrating the invention and should not be construed as limiting the scope of the invention which is properly delineated in the claims.

### EXAMPLES

First Emulsion: Silicone Emulsions with Grafted Silica
Emulsion 1: Silicone Emulsion with 5% Colloidal Silica Dispersion

Into a 2-liter round-bottom 3-necked flask equipped with a mechanical stirrer, J-kem thermal couple, and Friedrich cold water condenser, under stirring were charged hydroxyl-terminated polydimethylsiloxane emulsion (950 grams of about 50% solid content, BC 2747 obtained from Momentive Performance Materials Inc. with polymer viscosity >1000,000 cp), silica dispersion (50 grams of a ˜47% colloidal silica, obtained under the trade name of DVSTS030 from Nalco), antifoam agent (1 gram of SAG-10 from Momentive Performance Materials Inc.), 2-amino-2-methyl-1-propanol (20 grams obtained under the tradename AMP-95 from Dow Chemical), and tin catalyst emulsion (3 grams of 50% dioctyltin dineodecanoate obtained under the trade name of SM-2146c from Momentive Performance Materials Inc.). The stir speed was adjusted to about 400 rpm and the mixture was heated to 80° C. After stirring at 80° C. for 4 hours, the contents were cooled to room temperature to yield about 1 kilogram of Emulsion 1. Emulsion 1 has a Percent Active Weight Solids of approximately 47.7% and a colloidal silica dispersion content of approximately 5 wt % based on the total weight of emulsion.

Emulsion 2: Silicone Emulsion with 10% Colloidal Silica Dispersion

Into a 2-liter round-bottom 3-necked flask equipped with a mechanical stirrer, J-kem thermal couple, and Friedrich cold water condenser, under stirring were charged hydroxyl-terminated polydimethylsiloxane emulsion (900 grams of about 50% solid content, BC 2747 obtained from Momentive Performance Materials Inc. with polymer viscosity >1000,000 cp), silica dispersion (100 grams of a ˜47% colloidal silica, obtained under the trade name of DVSTS030 from Nalco), antifoam agent (1 gram of SAG-10 from Momentive Performance Materials Inc.), 2-amino-2-methyl-1-propanol (20 grams obtained under the tradename AMP-95 from Dow Chemical), and tin catalyst emulsion (3 grams of 50% dioctyltin dineodecanoate obtained under the trade name of SM-2146c from Momentive Performance Materials Inc.). The stir speed was adjusted to about 400 rpm and the mixture was heated to 80° C. After stirring at 80° C. for 4 hours, the contents were cooled to room temperature to yield about 1 kilogram of Emulsion 2. Emulsion 2 has a Percent Active Weight Solids of approximately 48.3% and a colloidal silica dispersion content of approximately 10 wt % based on the total weight of emulsion.

Emulsion 3: Silicone Emulsion with 30% Colloidal Silica Dispersion

Into a 2-liter round-bottom 3-necked flask equipped with a mechanical stirrer, J-kem thermal couple, and Friedrich cold water condenser, under stirring were charged hydroxyl-terminated polydimethylsiloxane emulsion (700 grams of about 50% solid content, BC 2747 obtained from Momentive Performance Materials Inc. with polymer viscosity >1000,000 cp), silica dispersion (300 grams of a ˜47% colloidal silica, obtained under the trade name of DVSTS030 from Nalco), antifoam agent (1 gram of SAG-10 from Momentive Performance Materials Inc.), 2-amino-2-methyl-1-propanol (20 grams obtained under the tradename AMP-95 from Dow Chemical), and tin catalyst emulsion (3 grams of 50% dioctyltin dineodecanoate obtained under the trade name of SM-2146c from Momentive Performance Materials Inc.). The stir speed was adjusted to about 400 rpm and the mixture was heated to 80° C. After stirring at 80° C. for 4 hours, the contents were cooled to room temperature to yield about 1 kilogram of Emulsion 3. Emulsion 3 has a Percent Active Weight Solids of approximately 47.7% and a colloidal silica dispersion content of approximately 30 wt % based on the total weight of emulsion.

Emulsion 4: Silicone Emulsion with 50% Colloidal Silica Dispersion

Into a 2-liter round-bottom 3-necked flask equipped with a mechanical stirrer, J-kem thermal couple, and Friedrich cold water condenser, under stirring were charged hydroxyl-terminated polydimethylsiloxane emulsion (400 grams of about 54% solid content, Silsoft NP-1 obtained from Momentive Performance Materials Inc. with polymer viscosity approx. 500,000 cP), silica dispersion (500 grams of a ˜47% colloidal silica, obtained under the trade name of DVSTS030 from Nalco), 76 grams of DI water, antifoam agent (1 gram of SAG-10 from Momentive Performance Materials Inc.), 2-amino-2-methyl-1-propanol (20 grams obtained under the tradename AMP-95 from Dow Chemical), and tin catalyst emulsion (3 grams of 50% dioctyltin dineodecanoate obtained under the trade name of SM-2146c from Momentive Performance Materials Inc.). The stir speed was adjusted to about 400 rpm, and the mixture was heated to 80° C. After stirring at 80° C. for 4 hours, the contents were cooled to room temperature to yield about 1 kilogram of Emulsion 4. Emulsion 4 has a Percent Active Weight Solids of approximately 45% and a colloidal silica dispersion content of approximately 50 wt % based on the total weight of emulsion.

### Second Emulsion: Amino Silicone Emulsions

### Emulsion 5

Into a 2-liter flask equipped with a mechanical stirrer and heating mantle was charged 500 grams of DI water, 20 grams of Cetyltrimethyl Ammonium Chloride solution (30%), 20 grams of Emulgen 1135S-70 (supplied from Kao Chemicals), and 2 grams of Tergitol 15-S-15 (supplied from Dow chemicals). The mixture was heated and stirred until all surfactants were dissolved. While the mixture was maintained at 35° C., 330 grams of DMC (mixture of silicone monomer D4, D5, D6, supplied from Momentive Performance Materials) was charged and continued to stir at 35° C. for an hour before homogenization.

Homogenization was carried out by APV homogenizer: the mixture in the flask prepared above was passed through APV with a pressure setting at 50/500 bar; this was repeated again for two passes and the emulsified mixture was collected back into flask. A KOH solution (1.9 grams of Potassium Hydroxide dissolved in 20 grams of DI water) was added and stirred at 80° C. for 5 hours. The mixture was then cooled down to 35° C., and a solution of N-beta-(Aminoethyl)-gamma-Aminopropyl trimethoxysilane (32.8 grams of Silquest A-1120 from Momentive Performance Materials Inc. dissolved in 65 grams of DI water) was added and mixed for 10 minutes. An acid solution (2.0 grams of Acetic acid dissolved in 5 grams of DI water) was then added, and the mixture was stirred for 30 minutes. In the end 0.9 grams of Proxel XL2 (supplied from Arxada) was added and stirred for 30 minutes. Around 1000 grams of Emulsion 5 was obtained.

### Emulsion 6

98.39 grams of XF 3905 (Silanol PDMS of viscosity ˜600 cP) and 1.54 g of Silquest A-1120 (from Momentive Performance Materials Inc.) were taken in a round bottom flask. The temperature of the reaction was set to 65° C. After reaching the set temperatures, 0.029 g of water and 0.44 g of Dibutyltin dilaurate (DBTDL) catalyst were added, and the reaction was carried out for 5 hours to obtain amino silicone polymer. In a separate container, 2 grams of nonionic surfactant (Grand 6047 from Grand Organics) and 18 grams of water were mixed using a rotor stator homogenizer at 1000 rpm. After making the homogeneous surfactant mixture, 30 grams of the above amino silicone polymer was emulsified using a rotor stator homogenizer at 2500 rpm. The resulting emulsion, i.e., Emulsion 6, contained approximately 60% solids and about 0.12% amine content.

### Emulsion 7

38 grams of XF 3905 (Silanol PDMS of viscosity ˜600 cP) and 10 grams Silquest A-1120 (from Momentive Performance Materials Inc.) were taken in a round bottom flask. The temperature of reaction was set to 65° C. After reaching set temperatures, 0.029 g of water and 0.22 g of Dibutyltin dilaurate (DBTDL) catalyst were added and the reaction was carried out for 6 hours to obtain amino silicone polymer. In a separate container, 2 grams of nonionic surfactant (Grand 6047 from Grand Organics) and 18 grams of water were mixed using a rotor stator homogenizer at 1000 rpm. After making a homogeneous surfactant mixture, 30 grams of the above amino silicone polymer was emulsified using a rotor stator homogenizer at 2500 rpm. The resulting emulsion, i.e., Emulsion 7, contained approximately 60% solids and about 1.64% amine content.

### Formulation Examples

### Comparative Example (A)

To a 600 mL plastic container, 37.13 grams of Sphericel 25P45 (available from Potters Engineered Glass Materials Division) was slowly added to the plastic container. Next, 137.26 grams of Rhoplex EC-1791 (available from Dow) was slowly added to the container. Using a mixing blade attached to a motor which monitors RPM, the two components were slowly mixed at 600 RPM for approximately 5 minutes or until the materials were well mixed. Next, 0.67 grams of Dispex AA 4144 EB (available from BASF) was slowly added dropwise, and the blended materials were allowed to mix for 5 minutes at 600 RPM. To this blend, added 2.66 grams of Acrysol RM-8W (available from Dow) and allowed the mixture to mix for 5 minutes at 600 RPM. The viscosity of this mixture in the container appeared too thick for application with a spatula blade, so the mixture was reduced with 55.00 grams of DI Water. The material was then allowed to mix for 1 hour at 1,200 RPM and then set aside. A viscosity of ˜9,500 cps was measured using a #63 Spindle Viscometer at 10 RPM. The theoretical % weight solids was 48.7% wt, the % volume solids was 72.9%, and the Pigment Volume Concentration was 80% vol.

### Comparative Example (B)

To a 300 mL plastic container, 20.00 grams of Sphericel 25P45 was slowly added to the plastic container. Next, 50.75 grams of BC2747 was slowly added, followed by adding 1.45 grams of AMP-95, then adding 0.22 grams of SM2146C, and 0.07 grams of SAG 10, which was then followed by adding 24.08 grams of Emulsion 5. Using a mixing blade attached to a motor which monitors RPM, the components were slowly mixed at 600 PRM for approximately 5 minutes or until the materials were well mixed. Next, 0.30 grams of Dispex AA 4144 EB was slowly added dropwise, followed by adding 0.67 gram of Laponite RD, and the materials were allowed to mix for approximately 5 minutes at 600 RPM. To this blend, 2.45 grams of Acrysol RM-8W was added and the mixture was allowed to mix for 5 minutes at 600 RPM. The viscosity of this mixture in the container appeared acceptable for application with a spatula blade, so the mixture was not reduced with DI water. The material was then allowed to mix for 1 hour at 1,200 RPM and then set aside. Theoretical % weight solids was 58.0% wt, % volume solids was 80.4% vol, and Pigment Volume Concentration was 80% vol.

### Comparative Example (C)

To a 600 mL plastic container, 36.96 grams of Sphericel 25P45 was slowly added to the plastic container. Next, 138.86 grams of Resin Silicone Emulsion 2 was slowly added to the container. Using a mixing blade attached to a motor which monitors RPM, the two components were slowly mixed at 600 RPM for approximately 5 minutes or until the materials were well mixed. Next, 0.54 grams of Dispex AA 4144 EB was slowly added dropwise and the blended materials were allowed to mix for 5 minutes at 600 RPM. To this blend, 2.14 grams of Acrysol RM-8W was added and mixed for 5 minutes at 600 RPM. The viscosity of this mixture in the container appeared acceptable for application with a spatula blade, so the mixture was not reduced with DI Water. The material was then allowed to mix for 1 hour at 1,200 RPM and then set aside. A viscosity of ˜9,600 cps was measured using a #63 Spindle Viscometer at 10 RPM. Theoretical % weight solids was 62.7% wt, % volume solids was 83.0% vol, and Pigment Volume Concentration was 80% vol.

### Comparative Example (D)

To a 600 mL plastic container, 36.86 grams of Sphericel 25P45 was slowly added to the plastic container. Next, 35.08 grams of Rhoplex EC-1791 was slowly added to the container followed by 102.84 grams of Resin Silicone Emulsion Sample 2. Using a mixing blade attached to a motor which monitors RPM, these three components were slowly mixed at 600 RPM for approximately 5 minutes or until the materials were well mixed. Next, 0.57 grams of Dispex AA 4144 EB was slowly added dropwise and the blended materials were allowed to mix for 5 minutes at 600 RPM. To this blend, 2.26 grams of Acrysol RM-8W was added and the mixture was allowed to mix for 5 minutes at 600 RPM. The viscosity of this mixture in the container appeared too thick for application with a spatula blade, so the mixture was reduced with 30.00 grams DI Water. The material was then allowed to mix for 1 hour at 1,200 RPM and then set aside. A viscosity of ˜7,400 cps was measured using a #63 Spindle Viscometer at 10 RPM. Theoretical % weight solids was 53.9% wt, % volume solids was 77.2% vol, and Pigment Volume Concentration was 80% vol.

### Comparative Example (E)

To a 600 mL plastic container, 16.25 grams of Sphericel 25P45 was slowly added to the plastic container. Next, 79.74 grams of Resin Silicone Emulsion 3 was slowly added. Using a mixing blade attached to a motor which monitors RPM, the components were slowly mixed at 600 PRM for approximately 5 minutes or until the materials were well mixed. Next, 0.27 grams of Dispex AA 4144 EB was slowly added dropwise and the materials were allowed to mix for approximately 5 minutes at 600 RPM. To this blend, 3.74 grams of Acrysol RM-8W was added and the mixture was allowed to mix for 5 minutes at 600 RPM. The viscosity of this mixture in the container appeared acceptable for application with a spatula blade, so the mixture was not reduced with DI water. The material was then allowed to mix for 1 hour at 1,200 RPM and then set aside. A viscosity of ˜4,200 cps was measured using a #64 Spindle Viscometer at 100 RPM. Theoretical % weight solids was 58.4%, % volume solids was 77.9%, and Pigment Volume Concentration was 80%.

Table 1 provides the formulation compositions on 100 grams total solution basis for Comparative Examples A, B, C, D and E.

### Comparative Example (F)

A coating composition was prepared using the ingredients listed in Table 4. Initially, 23 grams of water and 0.5 grams of dispersing agent (Alcosperse 602N from Nouryon) were blended using a Hauschild SpeedMixer. Subsequently, 19 grams of precipitated calcium carbonate (PCC) was added and dispersed in the same vessel. Once the PCC was fully dispersed, 56 g of Emulsion 4 was incorporated at a low mixing speed. Finally, 0.1 g of DBTDL catalyst and 1.4 g of Silquest A-1120 (from Momentive Performance Materials) were introduced to complete the formulation.

### Comparative Example (G)

A coating composition was prepared using the ingredients listed in Table 4. Initially, 17.2 grams of water and 0.5 grams of dispersing agent (Alcosperse 602N from Nouryon) were blended using a Hauschild SpeedMixer. Subsequently, 25.2 grams of precipitated calcium carbonate (PCC) was added and dispersed in the same vessel. Once the PCC was fully dispersed, 56 g of Emulsion 6 was incorporated at a low mixing speed. Finally, 0.1 g of DBTDL catalyst and 1.1 g of Silquest A-1120 (from Momentive Performance Materials) were introduced to complete the formulation.

### Example 1

To a 600 mL plastic container, 19.84 grams of Sphericel 25P45 was slowly added to the plastic container. Next, 54.63 grams of Emulsion 1 was slowly added to the container followed by 24.04 grams of Emulsion 5. Using a mixing blade attached to a motor which monitors RPM, the components were slowly mixed at 600 RPM for approximately 5 minutes or until materials were well mixed. Next, 0.30 grams of Dispex AA 4144 EB was slowly added dropwise and the blended materials were allowed to mix for 5 minutes at 600 RPM. To this blend, 1.19 grams of Acrysol RM-8W was added and the mixture was allowed to mix for 5 minutes at 600 RPM. The viscosity of this mixture in the container appeared acceptable for application with a spatula blade, so the mixture was not reduced with DI Water. The material was then allowed to mix for 1 hour at 1,200 RPM and then set aside. Theoretical % weight solids was 58.10% wt, % volume solids was 80.30% vol, and Pigment Volume Concentration was 80% vol.

### Example 2

To a 600 mL plastic container, 43.05 grams of Sphericel 25P45 was slowly added to the plastic container. Next, 71.28 grams of Emulsion 2 was slowly added to the container followed by adding 71.28 grams of Emulsion 3 and then followed by adding 52.84 grams of Emulsion 5. Using a mixing blade attached to a motor which monitors RPM, the components were slowly mixed at 600 RPM for approximately 5 minutes or until the materials are well mixed. Next, 0.66 grams of Dispex AA 4144 EB was slowly added dropwise, and the blended materials were allowed to mix for 5 minutes at 600 RPM. To this blend, 2.66 grams of Acrysol RM-8W was added, and the mixture was allowed to mix for 5 minutes at 600 RPM. The viscosity of this mixture in the container appeared acceptable for application with a spatula blade, so the mixture was not reduced with DI Water. The material was then allowed to mix for 1 hour at 1,200 RPM and then set aside. A viscosity of ˜4,800 cps was measured using a #63 Spindle Viscometer at 10 RPM. Theoretical % weight solids was 56.83% wt, % volume solids was 78.3% vol, and Pigment Volume Concentration was 80% vol.

### Example 3

To a 600 mL plastic container, 16.23 grams of Sphericel 25P45 was slowly added to the plastic container. Next, 62.31 grams of Emulsion 3 slowly added to the container followed by 20.21 grams of Emulsion 5. Using a mixing blade attached to a motor which monitors RPM, the two components were slowly mixed at 600 RPM for approximately 5 minutes or until the materials were well mixed. Next, 0.25 grams of Dispex AA 4144 EB was slowly added dropwise and the blended materials were allowed to mix for 5 minutes at 600 RPM. To this blend, 1.00 grams of Acrysol RM-8W was added and the mixture was allowed to mix for 5 minutes at 600 RPM. The viscosity of this mixture in the container appeared acceptable for application with a spatula blade, so the mixture was not reduced with DI Water. The material was then allowed to mix for 1 hour at 1,200 RPM and then set aside. A viscosity of ˜5,000 cps was measured using a #64 Spindle Viscometer at 100 RPM. Theoretical % weight solids was 55.9% wt, % volume solids was 76.6% vol, and Pigment Volume Concentration was 80% vol.

### Example 4

To a 600 mL plastic container, 19.19 grams of Sphericel 25P45 was slowly added to the plastic container. Next, 56.01 grams of Emulsion 2 slowly added to the container followed by 23.36 grams of Emulsion 5. Using a mixing blade attached to a motor which monitors RPM, the two components were slowly mixed at 600 RPM for approximately 5 minutes or until the materials were well mixed. Next, dropwise 0.29 grams of Dispex AA 4144 EB was slowly added, and the blended materials were allowed to mix for 5 minutes at 600 RPM. To this blend, 1.15 grams of Acrysol RM-8W was added, and the mixture was allowed to mix for 5 minutes at 600 RPM. The viscosity of this mixture in the container appeared acceptable for application with a spatula blade, so the mixture was not reduced with DI Water. The material was then allowed to mix for 1 hour at 1,200 RPM and then set aside. A viscosity of ˜3,000 cps was measured using a #64 Spindle Viscometer at 100 RPM. Theoretical % weight solids was 57.7% wt, % volume solids was 79.7% vol, and Pigment Volume Concentration was 80% vol.

### Example 5

To a 600 mL plastic container, 25.28 grams of Sphericel 25P45 was slowly added to the plastic container. Next, 52.06 grams of Emulsion 2 was slowly added to the container followed by 21.71 grams of Emulsion 5. Using a mixing blade attached to a motor which monitors RPM, the two components were slowly mixed at 600 RPM for approximately 5 minutes or until the materials were well mixed. Next, dropwise 0.27 grams of Dispex AA 4144 EB was slowly added followed by 0.12 grams of Laponite RD (available from BYK-Chemie), and the blended materials were allowed to mix for 5 minutes at 600 RPM. To this blend, 0.57 grams of Acrysol RM-8W was added and the mixture was allowed to mix for 5 minutes at 600 RPM. The viscosity of this mixture in the container appeared acceptable for application with a spatula blade, so the mixture was not reduced with DI Water. The material was then allowed to mix for 1 hour at 1,200 RPM and then set aside. Theoretical % weight solids was 61.1% wt, % volume solids was 84.1% vol, and Pigment Volume Concentration was 85% vol.

### Example 6 to 11

Table 2 provides the formulation compositions on 100 grams total solution basis for samples of Example 6 through Example 11. Samples were prepared in a similar manner and process as Examples 1 through Example 5.

### Example 12

A coating composition was prepared using the ingredients listed in Table 4. This time, 38.4 g of Emulsion 4 was blended with 32.8 g of Emulsion 6. Subsequently 0.5 grams of dispersion agent (Alcosperse 602N from Nouryon) was added along with 27 g of precipitated calcium carbonate (PCC). Finally, 0.1 g of DBTDL catalyst and 1.3 g of Silquest A-1120 (from Momentive Performance Materials) were introduced to complete the formulation. The coating composition was dried, and the mechanical properties were tested.

### Example 13

A coating composition was prepared using the ingredients listed in Table 4. This time, 52.1 g of Emulsion 4 was blended with 22.5 g of Emulsion 7. Subsequently 0.5 grams of dispersion agent (Alcosperse 602N from Nouryon) were added along with 10.8 g of water. After that 14.1 g of precipitated calcium carbonate (PCC) was added and speed mixed to obtain coating material. The coating material was further dried, and the mechanical properties were tested.

TABLE 1
Compositions of Comparative Examples

| | Comp | Comp | Comp | Comp | Comp |
|---|---|---|---|---|---|
| Material | Example A | Example B | Example C | Example D | Example E |
| Sphericel 25P45 | 15.96 | 20.00 | 20.71 | 17.76 | 16.25 |
| Rhoplex EC-1791 | 58.98 | 0.00 | 0.00 | 16.90 | 0.00 |
| BC2747 | 0.00 | 50.75 | 0.00 | 0.00 | 0.00 |
| AMP-95 | 0.00 | 1.45 | 0.00 | 0.00 | 0.00 |
| SM2146C | 0.00 | 0.22 | 0.00 | 0.00 | 0.00 |
| SAG 10 | 0.00 | 0.07 | 0.00 | 0.00 | 0.00 |
| Emulsion 2 | 0.00 | 0.00 | 77.79 | 47.53 | 0.00 |
| Emulsion 3 | 0.00 | 0.00 | 0.00 | 0.00 | 79.74 |
| Emulsion 4 | 0.00 | 0.00 | 0.00 | 0.00 | 0.00 |
| Emulsion 5 | 0.00 | 24.08 | 0.00 | 0.00 | 0.00 |
| Dispex AA 4144EB | 0.29 | 0.30 | 0.30 | 0.27 | 0.27 |
| Laponite RD | 0.00 | 0.67 | 0.00 | 0.00 | 0.00 |
| Acrysol RM-8W | 1.14 | 2.45 | 1.20 | 1.09 | 3.74 |
| DI WATER | 23.63 | 0.00 | 0.00 | 14.45 | 0.00 |
| TOTAL: | 100.00 | 100.00 | 100.00 | 100.00 | 100.00 |
| Viscosity(cps) #63Spindle, 10 RPM: | ~9,500 | n/a | ~9,600 | ~7,400 | n/a |
| Viscosity(cps) #64Spindle, 100 RPM: | n/a | ~2,300 | n/a | n/a | ~4,200 |
| % wt Solids: | 48.7 | 58.0 | 62.7 | 53.9 | 58.4 |
| % vol Solids: | 72.9 | 80.4 | 83.0 | 77.2 | 77.9 |
| PVC: | 80.0 | 80.0 | 80.0 | 80.0 | 80.0 |

TABLE 2
Compositions of Examples 1 through 11

| Material | Ex 1 | Ex 2 | Ex 3 | Ex 4 | Ex 5 | Ex 6 | Ex 7 | Ex 8 | Ex 9 | Ex 10 | Ex 11 |
|---|---|---|---|---|---|---|---|---|---|---|---|
| Sphericel | 19.84 | 17.81 | 16.23 | 19.19 | 25.28 | 20.15 | 19.79 | 18.26 | 16.42 | 16.35 | 16.03 |
| 25P45 | | | | | | | | | | | |
| Emulsion 5 | 24.04 | 21.86 | 20.21 | 23.36 | 21.71 | 8.62 | 14.24 | 37.92 | 7.23 | 12.07 | 33.93 |
| Emulsion 1 | 54.63 | 0.00 | 0.00 | 0.00 | 0.00 | 0.00 | 0.00 | 0.00 | 0.00 | 0.00 | 0.00 |
| Emulsion 2 | 0.00 | 29.49 | 0.00 | 56.01 | 52.06 | 69.76 | 64.51 | 42.42 | 0.00 | 0.00 | 0.00 |
| Emulsion 3 | 0.00 | 29.49 | 62.31 | 0.00 | 0.00 | 0.00 | 0.00 | 0.00 | 75.10 | 70.33 | 48.79 |
| Emulsion 4 | 0.00 | 0.00 | 0.00 | 0.00 | 0.00 | 0.00 | 0.00 | 0.00 | 0.00 | 0.00 | 0.00 |
| Dispex AA | 0.30 | 0.27 | 0.25 | 0.29 | 0.27 | 0.29 | 0.30 | 0.28 | 0.25 | 0.25 | 0.25 |
| 4144EB | | | | | | | | | | | |
| Laponite RD | 0.00 | 0.00 | 0.00 | 0.00 | 0.12 | 0.00 | 0.00 | 0.00 | 0.00 | 0.00 | 0.00 |
| Acrysol RM-8W | 1.19 | 1.08 | 1.00 | 1.15 | 0.57 | 1.18 | 1.17 | 1.12 | 1.00 | 1.00 | 1.00 |
| TOTAL: | 100.00 | 100.00 | 100.00 | 100.00 | 100.00 | 100.00 | 100.00 | 100.00 | 100.00 | 100.00 | 100.00 |
| Viscosity(cps) | n/a | ~4,000 | n/a | n/a | n/a | n/a | n/a | n/a | n/a | n/a | n/a |
| #63Spindle, | | | | | | | | | | | |
| 10 RPM: | | | | | | | | | | | |
| Viscosity(cps) | ~4,800 | n/a | ~5,000 | ~3,000 | n/a | ~3,200 | ~2,300 | ~3,200 | ~4,100 | ~4,500 | ~5,000 |
| #64Spindle, | | | | | | | | | | | |
| 100 RPM: | | | | | | | | | | | |
| % wt Solids: | 58.1 | 56.8 | 55.9 | 57.7 | 61.1 | 60.9 | 59.7 | 54.6 | 58.1 | 57.3 | 53.5 |
| % vol Solids: | 80.3 | 78.3 | 76.3 | 79.7 | 84.1 | 81.8 | 81.0 | 75.2 | 78.0 | 77.5 | 75.2 |
| PVC: | 80.0 | 80.0 | 80.0 | 80.0 | 85.0 | 80.0 | 80.0 | 80.0 | 80.0 | 80.0 | 80.0 |

TABLE 3
Composition of low-PVC paint formulations.

| | Comparative | Comparative | | |
|---|---|---|---|---|
| | Example F | Example G | Example 12 | Example 13 |
| Emulsion 4 | 56.0 | 0.0 | 38.4 | 52.1 |
| Emulsion 6 | 0.0 | 56.0 | 32.8 | 0.0 |
| Emulsion 7 | 0.0 | 0.0 | 0.0 | 22.5 |
| Alcosperse | 0.5 | 0.5 | 0.5 | 0.5 |
| 602N | | | | |
| Precipitated | 19.0 | 25.2 | 27.0 | 14.1 |
| Calcium | | | | |
| Carbonate | | | | |
| Water | 23.0 | 17.2 | 0.0 | 10.8 |
| Silquest | 1.4 | 1.1 | 1.3 | 0.0 |
| A-1120 | | | | |
| DBTDL | | | | |
| Catalyst | 0.1 | 0.1 | 0.1 | 0.0 |
| Total | 100.0 | 100.0 | 100.1 | 100.0 |

### Sample Analysis

An aluminum metal panel, 30-gauge×6-inch×12-inch, was covered with a PTFE adhesive backed film to allow for removal of the film articles being prepared. To build film thickness lengthwise, 32 mil×1 inch×12-inch metal shims were used. To build film thickness widthwise, ⅛-inch×4-inch×1-inch thick TPO panels were used.

A typical dimension used to prepare samples was 4-inch×10-inch×0.16 inches in thickness. The application typically occurred in two steps.

### Mixing

Prior to application, the liquid sample was placed into a high-speed mixer and mixed at 1000 RPM for 30 seconds. If the sample appeared to have uniform consistency, (e.g., no phase separation, clumps, or air bubbles) then the sample was ready for pouring. If not, then the sample was placed back into the high-speed mixer for another 30 seconds. This process iteration continued until the sample has sufficient consistency for pouring.

### Open Mold Preparation for Pouring Samples

First step in mold preparation used two 32 mil×1-inch×12-inch shims. The shims were placed one on top of the other to prepare a 64 mil thickness on either end of the 6-inch panel width. The ends were sealed with ⅛-inch×4-inch×1-inch thick TPO panels on each end. This created an open mold having a 4-inch width and 10-inch length.

Pouring Sample into Open Mold

The viscous liquid sample was then poured into the open mold such that ⅓ of the mold was covered with sample. A 6-inch putty knife or equivalent flat piece of metal was then used to spread the material smoothly and evenly into the mold cavity. Any excess was collected and placed back into the sample's container. If more material was required, additional sample was poured into the uncovered area of the cavity. Once uniform coverage was achieved, medium sized binder clips were used to fasten the mold's edges such that the cavity would maintain its geometry during drying under ambient temperature and humidity conditions for up to 30 minutes.

After approximately 30 minutes, or once the viscous sample was dry to the touch, the binder clips were removed and an additional three 32 mil×1-inch×12-inch shims were placed one on top of the existing metal shims on either side of the mold, creating a total depth of 160 mils.

The sample remaining in the container is then checked again for consistency, and if sufficiently homogeneous, the sample is poured onto the existing first sample application and spread into the mold cavity. The wet sample film thickness should be approximately 160 mils or over 4 mm in thickness. Once uniform coverage has been achieved, medium sized binder clips are again used to fasten the mold's edges such that the cavity.

### Drying Samples

The sample is then dried for at least 48 hours under ambient temperature and humidity conditions. To ensure full drying, the samples were also placed in a 120° F. drying oven for at least three days. Due to water volatilization, the samples may shrink in thickness by up to 29%.

Removing Samples from Mold

Once the samples were fully dried, a sharp edge knife was used to separate the experimental samples from the edges of the metal shims and the TPO panels.

The finished articles were then carefully separated from the PTFE film using finger force or using a lab spatula. Typical free film thicknesses were between 2.8 mm to 4.5 mm for Comparative examples A to E and Examples 1 to 11. Typical free film thicknesses were between 1 mm to 1.5 mm for Comparative examples F to G and Examples 12 to 13.

If higher film thicknesses are necessary, additional metal and plastic TPO shims can be added until the desired film thickness is reached. These can be prepared with ⅛-inch TPO shims on the ends.

Sample Conditioning Prior to Testing:

Once the films are fully separated from the mold, the free films can be further conditioned under ambient conditions or at 120° F. for an additional 72 hours prior to testing, or longer, if necessary.

### Test Methods

Sample Film Thicknesses were measured using Mitutoyo Absolute equipment.

Shore A hardness was measured using Rex Gauge Company equipment per ASTM D 2240 specification.

Tensile properties were measured using Instron Model 3345 equipment per ASTM D412.

TGA was measured using TA Instruments Discovery 55 TGA per ASTM E2550.

Test results are summarized in Tables 4 and 5.

TABLE 4
Summary of test results in 80-85 PV formulations

| | | | | Active | | | | |
|---|---|---|---|---|---|---|---|---|
| | | First silicone | Second | weight ratio | | | | |
| | Emulsion | emulsion | silicone | of | | | | |
| | without | (grafted on | emulsion | First:Second | | Tensile | | TGA Onset |
| | silica | colloidal | (with amino | silicone | Shore A | Strength | Elongation | Degradation |
| Formulation | grafting | silica) | silicone) | emulsion | Hardness | (psi) | (%) | Temp (° C.) |
| Comparative A | Rhoplex | | | | 15.2 | 32.0 | 27.6 | 320 |
| | EC-1791 | | | | | | | |
| Comparative B | BC2747 | | Emulsion 5 | 75/25 | 23 | Very Slow to Cure, Did Not Test | | |
| Comparative C | | Emulsion 2 | | | 6.4 | 10.3 | 19.9 | 413 |
| Comparative D | Rhoplex | Emulsion 2 | | | 5.8 | 16.0 | 8.6 | 350 |
| | EC-1791 | | | | | | | |
| Comparative E | | Emulsion 3 | | | 21 | 18.3 | 11.0 | n/a |
| Example 1 | | Emulsion 1 | Emulsion 5 | 75/25 | 31 | 68.0 | 30 | n/a |
| Example 2 | | Emulsion 2 + | Emulsion 5 | 37.5/37.5/25 | 35.6 | 96.1 | 50.1 | 409 |
| | | Emulsion 3 | | | | | | |
| Example 3 | | Emulsion 3 | Emulsion 5 | 75/25 | 37 | 107.6 | 34.8 | n/a |
| Example 4 | | Emulsion 2 | Emulsion 5 | 75/25 | 31 | 81.2 | 70.1 | n/a |
| Example 5 | | Emulsion 2 | Emulsion 5 | 75/25 | n/a | 52.7 | 32.1 | 410 |
| Example 6 | | Emulsion 2 | Emulsion 5 | 91/9 | 30 | 53.0 | 53 | n/a |
| Example 7 | | Emulsion 2 | Emulsion 5 | 85/15 | 29 | 65.5 | 57.1 | n/a |
| Example 8 | | Emulsion 2 | Emulsion 5 | 58.3/41.7 | 30 | 55.0 | 53.0 | n/a |
| Example 9 | | Emulsion 3 | Emulsion 5 | 91/9 | 43 | 78.7 | 17.6 | n/a |
| Example 10 | | Emulsion 3 | Emulsion 5 | 85/15 | 40 | 99.7 | 37.0 | n/a |
| Example 11 | | Emulsion 3 | Emulsion 5 | 58.3/41.7 | 34 | 80.8 | 31.7 | n/a |

TABLE 5
Summary of test results in low-PVC paint formulation

| | First silicone | Second silicone | Active | | | |
|---|---|---|---|---|---|---|
| | emulsion | emulsion | weight ratio of | | Tensile | |
| | (grafted on | (with amino | First:Second | Shore A | Strength | Elongation |
| Formulations | colloidal silica) | silicone) | silicone emulsion | Hardness | (psi) | (%) |
| Comparative | Emulsion 4 | | n/a | Not measurable (Brittle film) | | |
| Example F | | | | | | |
| Comparative | | Emulsion 6 | n/a | Not measurable | | |
| Example G | | | | (Film not formed) | | |
| Example 12 | Emulsion 4 | Emulsion 6 | 53.8/46.1 | 35 | 79.8 | 50 |
| Example 13 | Emulsion 4 | Emulsion 7 | 59.1/40.9 | 45 | 200.1 | 52 |

Examples 1 through 13 show higher Shore A, tensile, and elongation properties compared to their Comparative Examples while maintaining high silicone content. The benefit is that the finished articles and coatings will have better rigidity and flexibility versus their comparative examples, while also achieving higher thermal degradation temperatures. These properties can be provided all while employing low to high pigment volume concentrations.

While the above description contains many specifics, these specifics should not be construed as limitations on the scope of the invention, but merely as exemplifications of preferred embodiments thereof. Those skilled in the art may envision many other possible variations that are within the scope and spirit of the invention as defined by the claims appended hereto.

What is claimed is:

1. A silicone emulsion comprising:
(i) a first silicone emulsion comprising a polydiorganopolysiloxane grafted onto colloidal silica; and
(ii) a second silicone emulsion comprising an aminosilicone;
wherein a active weight ratio of the first silicone emulsion to the second silicone emulsion is from about 90:10 to about 10:90 based on the total weight of the first and second emulsion.

2. The silicone emulsion of claim 1, wherein the active weight ratio of the first silicone emulsion to the second silicone emulsion is from about 80:20 to about 20:80 based on the total weight of the first and second emulsion.

3. The silicone emulsion of claim 1, wherein the active weight ratio of the first silicone emulsion to the second silicone emulsion is from about 70:30 to about 30:70 based on the total weight of the first and second emulsion.

4. The silicone emulsion of claim 1, wherein the active weight ratio of the first silicone emulsion to the second silicone emulsion is from about 60:40 to about 40:60 based on the total weight of the first and second emulsion.

5. The silicone emulsion of claim 1, wherein the active weight ratio of the first silicone emulsion to the second silicone emulsion is from about 60:40 to about 90:10 based on the total weight of the first and second emulsion.

6. The silicone emulsion of claim 1, wherein the first silicone emulsion comprises the colloidal silica in an amount of from about 0.55 wt. % to about 50 wt. % based on the total weight of the colloidal silica and the polydiorganopolysiloxane.

7. The silicone emulsion of claim 1, wherein the first silicone emulsion comprises the colloidal silica in an amount of from about 7.5 wt. % to about 20 wt. % based on the total weight of the colloidal silica and the polydiorganopolysiloxane.

8. The silicone emulsion of claim 1, wherein the second emulsion has an amine content of from about 0.05 wt. % to about 10 wt. % based on the total weight of the second emulsion.

9. The silicone emulsion of claim 1, wherein the amino silicone emulsion comprises a polyorganosiloxane having an amino silane group at a terminal position of the polyorganosiloxane and/or pendant position to a silicon atom in a chain of the polyorganosiloxane.

10. The silicone emulsion of claim 1, wherein the second emulsion comprises an amine group derived from an aminosilane of the formula: 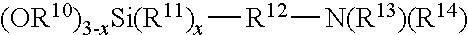
where R¹⁰ is a C1-C8 alkyl;
R¹¹ is selected from H, a C1-C12 alkyl, or C3-C10 cycloalkyl, or a C6-C30 aromatic containing group;
R¹² is selected from a C1-C12 alkylene;
R¹³ and R¹⁴ are independently selected from H, a C1-C12 alkyl, or —R¹⁵—N(R¹⁶)(R¹⁷), where R¹⁵ is a C1-C12 alkylene, R¹⁶ and R¹⁷ are independently selected from H and a C1-C12 alkyl; and
x is 0, 1, or 2

11. The silicone emulsion of claim 1, wherein the second emulsion comprises an amino group derived from aminopropyltrimethoxysilane, aminopropyltrimethoxysilane, aminobutyltriethoxysilane, aminoethylaminoisobutylmethyldiethoxysilane, p-aminophenyltrimethoxysilane, N-(2-aminoethyl-3-aminopropyl)triethoxysilane, aminoundecyltrimethoxysilane, and aminopropylmethyldiethoxysilane, phenylaminopropyltriemthoxy silane, methylaminopropyltriemthoxysilane, n-butylaminopropyltrimethoxy silane, t-butyl aminopropyltrimethoxysilane, N-methyl-3-amino-2-methylpropyltriemthoxysilane, N-ethyl-3-amino-2-methylpropyltrimethoxysilane, N-ethyl-3-amino-2-methylpropyidiethoxysilane, N-ethyl-3-amino-2-methylpropyoltriethoxysilane, N-ethyl-3-amino-2-methylpropylmethyidimethoxysilane, N-butyl-3-amino-2-methylpropyltriemthoxysilane, 3-(N-methyl-3-amino-1-methyl-1-ethoxy)propyltrimethoxysi lane, N-ethyl-4-amino-3,3-dimethylbutyidimethoxymethylsilane and N-ethyl-4-amino-3,3-dimethylbutyltrimethoxysilane, or N-cyclohexylaminopropyltrimethoxysilane, bis(trimethoxysilylpropyl)amine, bis((3-trimethoxysilyl)propyl)-ethylenediamine.

12. The silicone emulsion of claim 1, wherein the second emulsion comprises a cationic surfactant.

13. The silicone emulsion of claim 1, wherein the second emulsion comprises a nonionic surfactant.

14. The silicone emulsion of claim 1, wherein the first emulsion comprises an emulsion of at least one hydroxylated polydiorganopolysiloxane grafted onto at least one colloidal silica dispersion; at least one catalyst; at least one emulsion stabilizer; at least one surfactant; and water, wherein the at least one hydroxylated polydiorganopolysiloxane grafted onto the at least one colloidal silica dispersion contains residual silanol groups from the at least one hydroxylated polydiorganopolysiloxane.

15. The silicone emulsion of claim 14, wherein the hydroxylated polydiorganosiloxane has a weight average molecular weight of from about 250 to about 1,000,000.

16. The silicone of claim 14, wherein the hydroxylated polydiorganosiloxane is a hydroxyl-terminated polydimethylsiloxane.

17. The silicone emulsion of claim 14, wherein the colloidal silica dispersion comprises silica particles having an average particle size of from about 5 to about 150 nanometers.

18. A coating composition comprising the silicone emulsion of claim 1.

19. The coating composition of claim 18 comprising one or more of an organic resin, a polysiloxane resin, a solvent, a filler, a dispersing agent, a wetting agent, a defoamer, a plasticizer, a thickener, a wax, a colorant, an antioxidant, a UV stabilizer, a biocide, a coalescing agent, or a combination of two or more thereof.

20. A coating or article formed from the silicone emulsion of claim 1.

21. A coating or article formed from a coating composition of claim 18.

22. An article comprising the silicone emulsion or a coating composition comprising the silicone emulsion of claim 1 disposed on at least a portion of a surface of the article.

23. The article of claim 22, comprising a coating formed from the silicone emulsion.

24. A method of making a silicone emulsion comprising mixing (i) a first silicone emulsion comprising a polydiorganopolysiloxane grafted onto colloidal silica; and (ii) a second silicone emulsion comprising an aminosilicone, wherein an active weight ratio of the first silicone emulsion to the second silicone emulsion is from about 90:10 to about 10:90 based on the total weight of the first and second emulsion.
